(19) United States
(12) Patent Application Publication
(10) Pub. No.: US 2025/0287053 A1
(43) Pub. Date: Sep. 11, 2025

(54) SALIENCY-GUIDED PACKET LOSS MITIGATION FOR CONTENT STREAMING SYSTEMS AND APPLICATIONS

(71) Applicant: Nvidia Corporation, Santa Clara, CA (US)

(72) Inventors: Yuanhang Su, Sunnyvale, CA (US); Amrita Mazumdar, Asbury Park, NJ (US); Andrija Bosnjakovic, Redmond, WA (US); Johannes Zimmermann, Berlin (DE)

(21) Appl. No.: 18/598,777

(22) Filed: Mar. 7, 2024

(51) Int. Cl. H04N 21/238; H04N 21/234; H04N 21/24

(52) U.S. Cl. CPC H04N 21/238; H04N 21/234; H04N 21/2402

(57) ABSTRACT

Approaches presented herein provide systems and methods to selectively apply packet loss mitigation methods to one or more regions of a frame that have a sufficient importance value. The importance value may be determined by a saliency map generated for the frame that determine the most important content elements or regions of the frame. An importance value may be computed based on the saliency map and then, for areas of sufficient importance, selective mitigation methods may be used to reduce bandwidth, conserve compute resources, and provide error correction or duplication for important regions of the frame.

### BACKGROUND

Content streaming, such as video streaming, involves encoding and transmitting data over a network. A recipient may receive and decode the data for viewing on a device. For streaming applications, data may be lost during transmission. When the decoder receives the data with lost packets, the decoded video may include visible artifacts or stuttering due to the information lost from these packets. Error mitigation techniques, such as the transmission of forward error correction (FEC) packets, may reduce instances of lost data. However, transmission of error mitigation data may reduce the bandwidth available for the data itself, which may be unsuitable for low-latency streaming applications, such as high definition video content, video game streaming, and various other applications.

### BRIEF DESCRIPTION OF THE DRAWINGS

Various embodiments in accordance with the present disclosure will be described with reference to the drawings, in which:

FIG. 1A illustrates an example environment for streaming content, in accordance with various embodiments;

FIG. 1B illustrates an example representation of packet transmission over a network, in accordance with various embodiments;

FIG. 1C illustrates an example representation of packet loss, in accordance with various embodiments;

FIG. 1D illustrates an example representation of frame segmentation and of a packet loss within a segment, in accordance with various embodiments;

FIG. 1E illustrates an example representation of whole frame packet loss mitigation, in accordance with various embodiments;

FIG. 2A illustrates an example environment for packet loss mitigation, in accordance with at least one embodiment;

FIG. 2B illustrates an example representation for determining region saliency scores based on a saliency map, in accordance with various embodiments;

FIGS. 3A-3C illustrate example representations of data transmission using selective packet loss mitigation methods, in accordance with various embodiments;

FIG. 4A illustrates an example process for generating a data stream with mitigation packets, in accordance with various embodiments;

FIG. 4B illustrates an example process for generating a data stream with mitigation packets, in accordance with various embodiments;

FIG. 5A illustrates an example process for generating a network payload with selective mitigation data, in accordance with various embodiments;

FIG. 5B illustrates an example process for generating a data packet with selective mitigation data, in accordance with various embodiments;

FIG. 6 illustrates components of a distributed system that can be utilized to update or perform inferencing using a machine learning model, according to at least one embodiment;

FIG. 7A illustrates inference and/or training logic, according to at least one embodiment;

FIG. 7B illustrates inference and/or training logic, according to at least one embodiment;

FIG. 8 illustrates an example data center system, according to at least one embodiment;

FIG. 9 illustrates a computer system, according to at least one embodiment;

FIG. 10 illustrates a computer system, according to at least one embodiment;

FIG. 11 illustrates at least portions of a graphics processor, according to one or more embodiments;

FIG. 12 illustrates at least portions of a graphics processor, according to one or more embodiments;

FIG. 13 is an example data flow diagram for an advanced computing pipeline, in accordance with at least one embodiment;

FIG. 14 is a system diagram for an example system for training, adapting, instantiating and deploying machine learning models in an advanced computing pipeline, in accordance with at least one embodiment; and

FIGS. 15A and 15B illustrate a data flow diagram for a process to train a machine learning model, as well as client-server architecture to enhance annotation tools with pre-trained annotation models, in accordance with at least one embodiment.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

The systems and methods described herein may be used by, without limitation, non-autonomous vehicles or machines, semi-autonomous vehicles or machines (e.g., in an in-cabin infotainment or digital or driver virtual assistant application)), autonomous vehicles or machines, piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, trains, underwater craft, remotely operated vehicles such as drones, and/or other vehicle types. Further, the systems and methods described herein may be used for a variety of purposes, by way of example and without limitation, for machine control, machine locomotion, machine driving, synthetic data generation, model training or updating, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational artificial intelligence (AI), generative AI with large language models (LLMs), light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems for performing generative AI operations using LLMs, systems for performing light transport simulation, systems for performing collaborative content creation for 3D assets, systems implemented at least partially using cloud computing resources, and/or other types of systems.

Approaches in accordance with various embodiments are directed toward a method for targeted packet loss mitigation in data streaming. In at least one embodiment, an input frame (e.g., video frame) is provided to an encoder that may segment the frame into different regions. Systems and methods may also incorporate a saliency map to identify important portions of the frame, which may then correspond to important regions. In at least one embodiment, saliency information to generate one or more saliency maps may be gathered by monitoring users interacting with particular content and then applying one or more algorithms to identify salient regions of a frame. Furthermore, saliency maps may be generated using one or more machine learning systems to evaluate regions of a frame, identify and/or classify content within the regions, and then assign a representative level of saliency based on the identified and/or classified content. A saliency map may also be pre-generated for particular content. Based on the saliency map, one or more regions may be selected to include some type of packet loss mitigation method(s) (e.g., error correction methods), such as forward error correction (FEC), packet duplication, or combinations of these and other methods. These mitigation methods may be selectively applied to particular regions that have or otherwise meet a threshold level of saliency (e.g., are determined to be important), which may reduce the risk of packet loss pertaining to those regions and decrease network traffic pertaining to the whole frame. Systems and methods may also combine the techniques for packet loss mitigation, such as using FEC for a certain level of importance, using both FEC and packet duplication for highly important regions, and/or the like.

Various embodiments are directed toward systems and methods to selectively apply one or more targeted packet loss mitigation methods to particular regions of a frame; for example, a frame that is part of a sequence of frames in a video or other type of content. In at least one embodiment, one or more saliency maps are used to determine or assign saliency coefficients to different regions. The regions may be based on one or more segmentation algorithms and, in at least one embodiment, regions may not be the same size and/or distributed uniformly over the frame. For example, one segmentation technique may segment the frame into four different regions, each having an equal size. However, another technique may segment the frame into any number of regions having different sizes. In at least one embodiment, saliency maps and/or deep learning techniques may be used to guide segmentation. For example, in an example associated with video games, it may be determined that for a certain game particular regions of the screen will always be important, such as regions that show a mini-map, health bar, and/or the like. Accordingly, these particular regions may be segmented within an area that includes only the likely important features, thereby potentially having regions that are not the same size. In at least one embodiment, individual regions may be analyzed against one or more saliency maps and then, if a given region is deemed important based on one or more metrics, one or more packet loss mitigation methods may be used for the important regions. In this manner, the costs associated with packet loss mitigation may be limited to particularly selected regions of the frame instead of applying the methods to the entire frame.

Systems and methods may provide bandwidth preservation through selective application of packet loss mitigation methods for video frame regions to improve upon the drawbacks of conventional techniques in video streaming. Conventional systems may use packet loss mitigation methods for the entirety of a video stream or for an entire frame and therefore increase overall consumption of network bandwidth, which can result in higher latency, slower transmission speeds, and lower available bitrate for video quality. Embodiments of the present disclosure address these drawbacks, while still providing for improved video streaming, by selectively using packet loss mitigation methods for regions of video frames that are deemed most important (e.g., have a saliency value that satisfies one or more metrics).

Various other such functions can be used as well within the scope of the various embodiments as would be apparent to one of ordinary skill in the art in light of the teachings and suggestions contained herein.

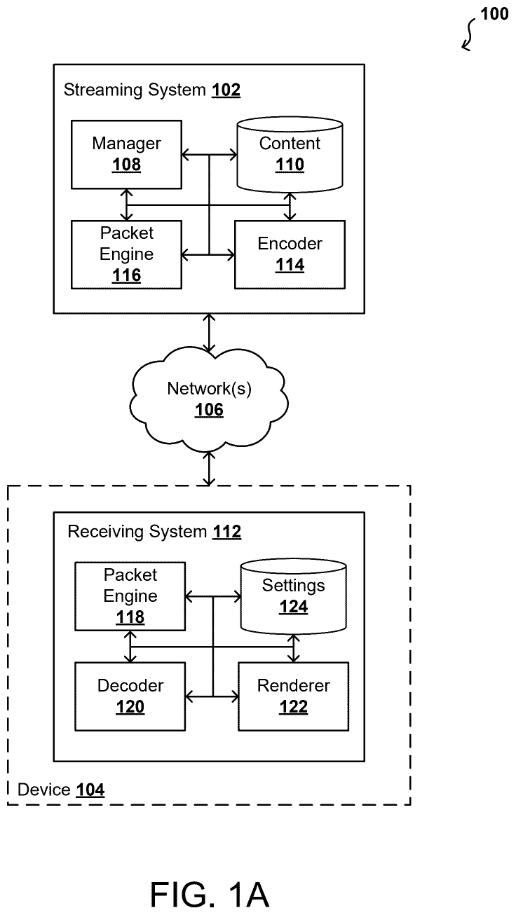

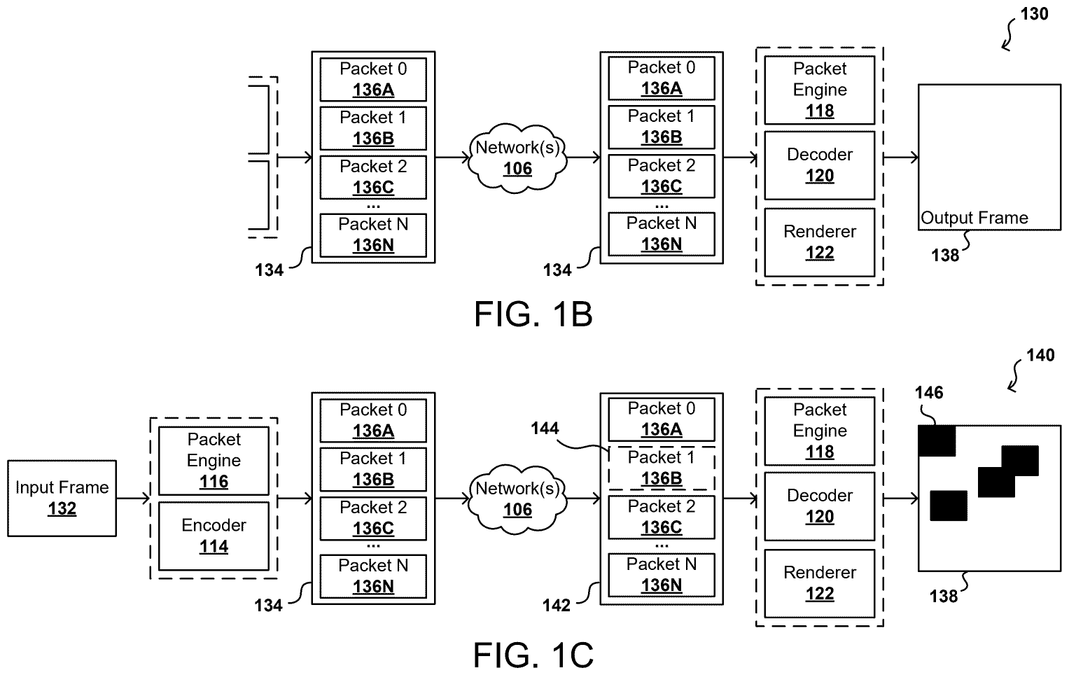

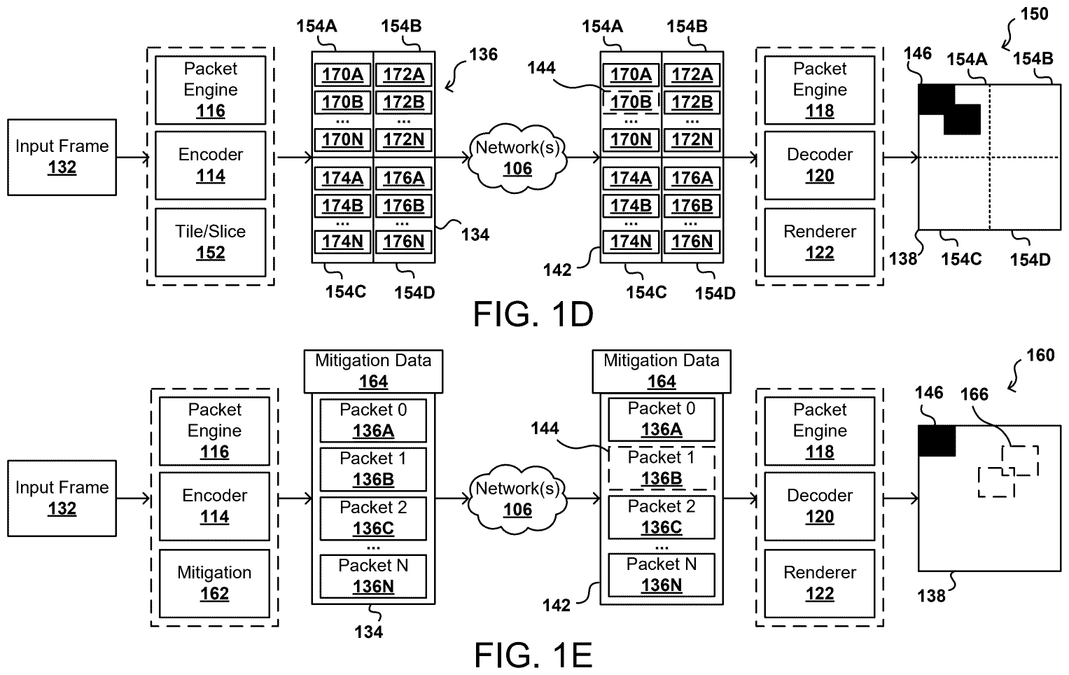

FIG. 1A illustrates an environment 100 that can be used with embodiments of the present disclosure. In this example, a streaming system 102 is used to provide (e.g., stream, transmit, etc.) data (e.g., video data, audio data, content data, etc.) as part of one or more network packets to a device 104 using one or more networks 106. In at least one embodiment, a manager 108 may receive a request or instruction from the device 104 to transmit information, such as streaming video data, using the one or more networks 106. Responsive to the request, the manager 108 may identify the requested content, upon verifying the device 104 is authorized to receive the content, within a content datastore 110. The manager 108 may also be deployed to execute one or more features associated with the data, including rate control signals and the like. In at least one embodiment, the content is video data that may correspond to video frames of a video stream generated from any suitable source, including a video playback process or a gaming process (e.g., video output from remotely executed video games), among other sources of video data. The provided data may also include audio data in various embodiments, as well as overlays and other information that may be integrated into, or added to, the video data. In some implementations, the streaming system 102 can execute one or more applications or games that generate the video data. Additionally, in various embodiments, the streaming system 102 may provide access to different applications or games to generate the video data.

In at least one embodiment, the data can be generated as an output of any process that generates frames of video information. For example, video data may be generated as an output of a rendering process for a video game executed by the streaming system 102 and/or as an output of a rendering process associated with a content delivery network (CDN) to provide requested content to the device 104. In a remote gaming configuration, the streaming system 102 may execute one or more game applications and may receive input data transmitted from the device 104 and/or a receiving system 112 of the device 104 via the network 106 to control the game applications. Similarly, commands could be sent and received to control video playback for other content. Frames of the video data may be generated at a predetermined frame rate, including but not limited to thirty frames-per-second, sixty frames-per-second, and so on. Furthermore, frames of the video data may be provided at a predetermined resolution, which may be based on bandwidth associated with the network 106, device hardware capabilities, user preferences, or combinations thereof.

The streaming system 102 includes an encoder 114, for example in embodiments associated with video data, to encode the video data into a suitable format for transmission over the network 106. The encoder 114 may generate an encoded bitstream according to one or more codecs. Encoding the video data may reduce the overall amount of information transmitted to the receiving system 112. The encoder 114 may use any combination of hardware or software to encode the video data and may convert the video data to conform to one or more codec standards, including by way of non-limiting example h.264 (AVC), h.265 (HEVC), h.266 (VVC), AV1, VP8, VP9, or any other video codec. Furthermore, it should be appreciated that codecs may also be used for audio data. In at least one embodiment, the encoder 114 generates the encoded bitstream continuously (e.g., as frames are generated by a source). However, the encoder 114 may also be used to prepare the bitstream in advance of a request to receive the content.

The encoder 114 may be configured to perform various compression techniques to encode the video data. For example, the encoder 114 may perform intra-frame compression techniques and/or inter-frame compression techniques, among various other functionality. In some implementations, the encoded bitstream may include audio data, which may be generated by the encoder 114 using a suitable audio encoding process. In some implementations, audio data may be formatted as a separate encoded bitstream.

Once the encoder 114 has generated the encoded bitstream, the encoded bitstream may be provided as input to a packet engine 116 (e.g., a packetizer). The packet engine 116 may be used to divide the encoded bitstream into one or more parts and can include these parts in the payload of a sequence of network packets. The network packets may be, for example, user datagram protocol (UDP) packets or other suitable transport-level packets. The payload of the network packets may include one or more streaming protocol packets, which include the portions of the encoded bitstream in their respective payloads. The streaming protocol packets may be generated, for example, according to the real-time transport (RTP) protocol, or any other protocol that provides a mapping between subsets of portions of the encoded bitstream corresponding to frame regions and streaming protocol packets. Additionally, in at least one embodiment, mapping may be provided as an encoding technique, such as slice/tile-based encoding for streaming, as discussed herein. In operation, the packet engine 116 may divide the encoded bitstream into parts that are each included in payloads of respective RTP packets. The packets may include data for a variety of different portions of the frame. In at least one non-limiting example including RTP, the packet engine 116 may generate a mapping between each network packet and the video data by including a sequence number that indicates the order in which the packets should be arranged for decoding and rendering. For example, a packet engine 118 (e.g., a downstream packet engine, a depacketizer, etc.) associated with the receiving system 112 may identify different packets in the sequence to determine whether packets have been lost. A lost packet may refer to a network packet that does not reach a receiver in time (e.g., a threshold period of time). The lost packet may contain a part of a frame/slice/tile or in some cases a complete frame/slice/tile. Packet loss may also refer to information loss, which may cause negative impacts to content such as visual artifacts, temporal inconsistencies, and the like.

As discussed herein, one or more features of the packets of data may be based, at least in part, on properties of the network 106, the device 104, user preferences, and/or the like. For example, the packet engine 116 may receive information related to network characteristics and may select different parameters, such as prioritizing one feature over another (e.g., speed over reliability). As another example, the packet engine 116 may generate packets based on a maximum transmission unit of the network 106.

The receiving system 112 may receive the data packets over the network 106, for example using one or more interfaces. The receiving system 112 may execute as a part of a device 104 that may include a display, or be coupled to a display, to present decoded content, such as video content. In certain embodiments, the downstream packet engine 118 can receive the network packets transmitted from the streaming system 102 and assemble one or more decodable units of video data to provide to a decoder 120. When assembling the decodable units of data, the downstream packet engine 118 can determine whether one or more network packets were lost during transmission.

Upon receiving the network packets from the streaming system 102, the downstream packet engine 118 can store and reorder the packets included in the received network packets. For example, the downstream packet engine 118 may use sequence numbers, such as those described with respect to RTP packets, to verify that the packets are reconstructed in the correct order. For example, the downstream packet engine 118 may extract the packets from the payload and can store the packets in a container, indexed by the sequence number of each packet. As new network packets are received, the downstream packet engine 118 can access the sequence number in the header of each packet and store the packet in the container in the correct order.

Once the packets have been ordered, the downstream packet engine 118 can reassemble the encoded bitstream transmitted by the streaming system 102 by concatenating the payload of each packet in the correct order. For example, the encoded bitstream may correspond to a frame of the video data, and the downstream packet engine 118 can reassemble the encoded bitstream corresponding to the frame based at least on the payloads of each packet. In doing so, the downstream packet engine 118 can determine that one or more network packets have been lost if a missing sequence number in the sequence of packets is identified. For example, packets may have consecutive sequence numbers, or sequence numbers that change based at least on a predetermined pattern. The downstream packet engine 118 may be used to evaluate the packets in the container to determine whether sequence numbers are missing. As discussed herein, systems and methods may be used to implement packet loss mitigation methods to reduce a likelihood of missing packets and/or to provide error correction techniques that may be used to recover data associated with missing packets.

The decoder 120 can receive, parse, and decode the encoded bitstream assembled by the downstream packet engine 118. For example, the decoder 120 can parse the encoded bitstream to extract any associated video metadata, such as the frame size, frame rate, or audio sample rate. In some embodiments, the decoder 120 can identify the codec based at least on the metadata and decode the encoded bitstream using the identified codec to generate video data and/or audio data. In at least one embodiment, such video metadata may be transmitted in one or more packets that are separate from the network packets that include video data. This may include decompressing or performing the inverse of any encoding operations used to generate the encoded bitstream at the streaming system 102. The decoder 120, upon generating the decoded video data for a frame of video, can provide the decoded video frame data to a renderer 122 for rendering.

The renderer 122 can render and display the decoded video data received from the decoder 120. The renderer 122 can render the decoded video data on any suitable display device, such as a monitor, a television, or any other type of device capable of displaying decoded video data. In at least one embodiment, the renderer 122 stores the decoded video data in a frame buffer and draws the frame buffer contents for the current frame to the display device. The renderer 122 may perform multiple layers of rendering, such as overlaying graphics or text on top of the video frames. In at least one embodiment, one or more of the packet extraction, decoding, or rendering processes may be controlled by one or more settings stored in a settings datastore 124. For example, decoding codecs or settings may be stored. As another example, rendering preferences, such as bitrates, color preferences, and/or the like may be used to control the rendered outputs on the display.

FIGS. 1B and 1C illustrate example environments 130, 140 for transmitting content, such as streaming video content, over one or more networks 106. In the environments 130, 140, an input frame 132 is processed by a provider or streaming system (such as the system 102 in FIG. 1A), to packetize and encode the input frame 132. For example, the input frame 132 may be part of a sequence of frames in a video that is being streamed by one or more client devices. Additionally, the input frame 132 may be a frame within a streaming video game or any other content that may be streamed by an end user. In this example, the input frame 132 is processed by the packet engine 116 and the encoder 114 to generate a group of network packets 134. The group of network packets 134 may refer to one or more network packets or a network payload that may represent individual sets or collections of individual packets 136 corresponding to different information associated with the input frame 132. One collection of individual packets of the group of network packets 134 is shown for clarity and as a non-limiting example. In this example, the packets 136 are represented by numbers (0-N) and/or letters (A-N) and it should be appreciated that there may be more or fewer packets 136 and that a number or size of packet generation and/or network packet generation may be based on one or more preferences and or parameters of the network 106 and/or the receiving client device.

The network packet 134 is transmitted over the network 106 and received at the client device for depacketizing, decoding, rendering, and the like. For example, in an example where transmission is successful, the network packet 134 arrives with all of the packets 136 (e.g., the packets 136A-136N). That is, no packets 136 have been lost during transmission. As a result, the received network packet 134 may be processed by the packet engine 118, the decoder 120, and the renderer 122 to generate an output frame 138 for viewing at the client device.

FIG. 1C illustrates the transmission process in the environment 140 where one or more packets 136 are lost. For example, a received network packet 142 in FIG. 1C is missing one or more of the packets 136. As shown, the packet 136B (Packet 1) is missing from the received network packet 142 and may be referred to as a lost packet 144. The lost packet 144 may represent information associated with the input frame 132, such as features within the frame, color, and/or the like. Because the packet 136B is missing, during decoding and rendering, the output frame 138 may be generated with visible artifacts 146 or stutter caused by waiting for missing packets 136 to be resent or the next video frame to be sent. Accordingly, video quality and smoothness are decreased along with user satisfaction, which may lead to users not consuming content from certain providers. Systems and methods of the present disclosure address and overcome these problems by selectively applying packet loss mitigation methods that may be incorporated into the network packet 134.

FIG. 1D illustrates an environment 150 including a transmission process that incorporates tiling and/or slicing. In this example, when the streaming system packetizes and/or encodes the input frame 132, a tile/slice engine 152 may be used to segment or otherwise divide the input frame 132 into two or more regions 154. The two or more regions may include one or more horizontal slices, tiles, sequence(s) of macroblocks, or any other sub-units of a video frame that may be encoded as a distinct part of a bitstream and then subsequently decoded. The size and type of each region may be specified based at least on the video codec used to encode the content.

In at least one embodiment, the tile/slice engine 152 may divide the input frame 132 into discrete regions (e.g., slices, tiles, segments, etc.) and the encoder 114 may associate the bitstream location of each slice or tile to a set of coordinates that indicate a selected region. The encoder 114 can then encode each frame region so it can be included in the encoded bitstream, where each encoded slice or tile therefore corresponds to a respective region of the input frame 132. The geometry of the regions may be rectangular slices, tiles, contiguous sequence(s) of macroblocks, or any other logical sub-unit of a video frame that may be encoded as a distinct part of the encoded bitstream and decoded as a distinct part of the decoded data. In some embodiments, a region may have the same width as the input frame 132 (e.g., a horizontal slice). In some embodiments, a region may have the same height as the input frame 132 (e.g., a vertical tile). To render an encoded bitstream, the decoder 120 can decode each encoded region of the encoded bitstream and provide the decoded data to the renderer 122 to generate the output frame 138. In some embodiments, each encoded region of the encoded bitstream may be a single decodable unit of encoded video data, which may be rendered independently from other encoded regions.

In this example, each of the regions 154A-154D may include individual packets 136 associated with data for a particular region, which is then provided as part of the network packet 134. For clarity, the individual packets 136 may be referred to as packets 170A-170N within the region 154A, as packets 172A-172N within the region 154B, as packets 174A-174N within the region 156C, and as packets 176A-176N within the region 154D. The use of A-N is not intended to denote that each region 154A-154D includes the same number of individual packets. For example, the number of packets 172A-172N may be different from the number of packets 174A-174N. Accordingly, the region 154A includes the packets 170A-170N associated with content within the region 154A. Similarly, the region 154B includes the packets 172A-172N for content within the region 154B. As shown in FIG. 1D, packet losses may only affect particular regions 154 of the output frame 138. In this example, the packet 170B associated with the region 154A is considered lost, as indicated by the label 144 for the packet 170B in the region 154A in the received network packet 142. Accordingly, when rendered, the output frame 138 may only include the artifacts 146 in the decoded region 154A, while the remaining decoded regions, such as the decoded region 154D, are unaffected by the packet loss.

FIG. 1E illustrates an environment 160 including a transmission process that incorporates mitigation techniques. In this example, a mitigation engine 162 is incorporated at the streamer service to use one or more mitigation techniques to correct for lost packets, such as error correction methods that may include FEC or packet duplication methods, among other options. In at least one embodiment, mitigation methods may refer to one or more algorithms that involve transmitting additional network packets, which include data associated with error correction, along with the original network packets. The additional error correction data may be redundant data, such as duplicative information for a packet. A client device receiving the network packet from a streaming server may then use this additional data to reconstruct the original packets.

In at least one embodiment, the mitigation engine 162 may generate or use metadata that is separate from the encoded bitstream. Mitigation data 164 may be generated and encoded with the bitstream as part of the network packet 134. The mitigation data 164 may be used to correct errors that may occur during data transmission or may be used to send one or more duplicate packets. Prior to generating the mitigation data 164, the packet engine 118 can generate the network packets 134 and send the mitigation data 164 along with the network packets 134. The mitigation data 164 may include error correction data, which may be FEC data, computed from payloads of the video streaming network packets 134. In the example of FEC, the mitigation data 164 may be transported together with network packets 134 that carry the encoded input frame 132. To generate the mitigation data, the mitigation engine 162 may apply an FEC encoding algorithm to the payload data of the network packets 134 that include the encoded bitstream data. Some example encoding algorithms include Reed-Solomon encoding, Hamming encoding, Low-Density Parity-Check (LDPC) encoding, Turbo encoding, Raptor encoding, Tornado encoding, Fountain encoding, Convolutional encoding, Bose-Chaudhuri-Hocquenghem (BCH) encoding, Golay encoding, Reed-Solomon product (RS-product) encoding, and Polar encoding, among others.

Rather than generating mitigation data 164 for all network packets 136 uniformly, as shown in FIG. 1E, systems and methods may generate mitigation data 164 using additional consideration. In at least one embodiment, such as where FEC is used, systems and methods generate a particular portion of mitigation data 164 for the entire input frame 132 and/or a portion of the input frame 132 encoded bitstream. The mitigation data may indiscriminately cover the portion of the encoded frame bitstream. In some embodiments, the percentage of the network packets 136 for which mitigation data 164 is generated may be based upon a percentage configuration. For example, mitigation data for a predetermined percentage of the network packets 136 may be generated with a bias towards generating mitigation data 164 for packets that store selected portions of the encoded bitstream. The mitigation data 164 may be generated as a predetermined percentage of the sequence of network packets 136 for a frame of video, such as the input frame 132. Within that predetermined percentage, mitigation data 164 may be generated that is weighted towards network packets 136 carrying one or more portions of the encoded stream. In a non-limiting example where a video frame has a 20% bandwidth “budget” for mitigation data 164, carrying mitigation data 164 equal to 20% of the generated network packets 136 for the input frame 132 may be generated. In at least one embodiment, the percentage of network packets 136 for which the mitigation data 164 is generated may be a function of the bandwidth allocated for streaming content that includes the input frame 132. The percentage of bandwidth occupied by the mitigation data 164 may be a function of the capabilities of the network.

In this example, the received network packets 142 do not include all of the packets 136, and the packet 136B (Packet 1) is shown as the lost packet 144. However, one or more decoding algorithms and/or the packet engine 118 may be deployed to obtain the mitigation data 164 and to include processing to recover lost or corrupted information. For example, the illustrated output frame 138 includes artifacts 146, but the illustrated example also includes recovered areas 166 that are recovered and rendered using the mitigation data 164.

Applying mitigation techniques to the entire network packet 134 may have high compute and transmission costs. For example, as noted herein, the inclusion of mitigation data occupies portions of the available bandwidth for data transmission. As a result, more mitigation data reduces available bandwidth for streamed data, which my reduce quality and/or increase latency. Systems and methods of the present disclosure address and overcome this problem by selectively applying different packet loss mitigation methods to particularly selected portions of input frames based, at least in part, on saliency information. That is, packet loss mitigation methods may be applied to regions deemed salient or important, which may be based on information related to the content within a given region of a frame. For example, a saliency map may be used to identify important regions of a frame and, for those important regions, one or more packet loss mitigation methods may be applied. As a result, different methods may be applied to target certain portions of the frame to reduce bandwidth use of the mitigation techniques while increasing a likelihood that the most significant portions of the frame will be made available for the end user.

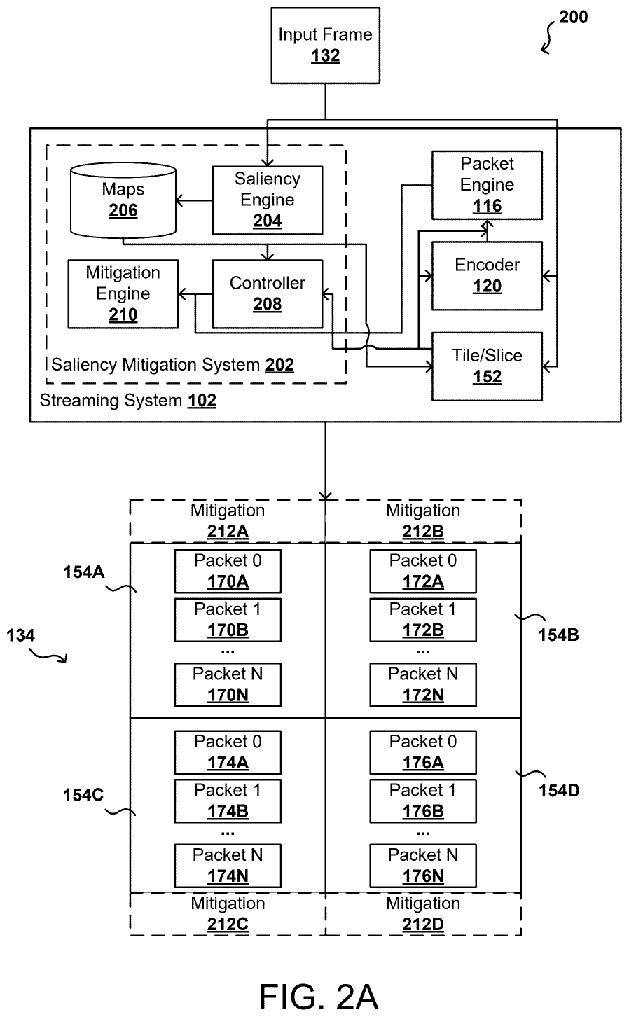

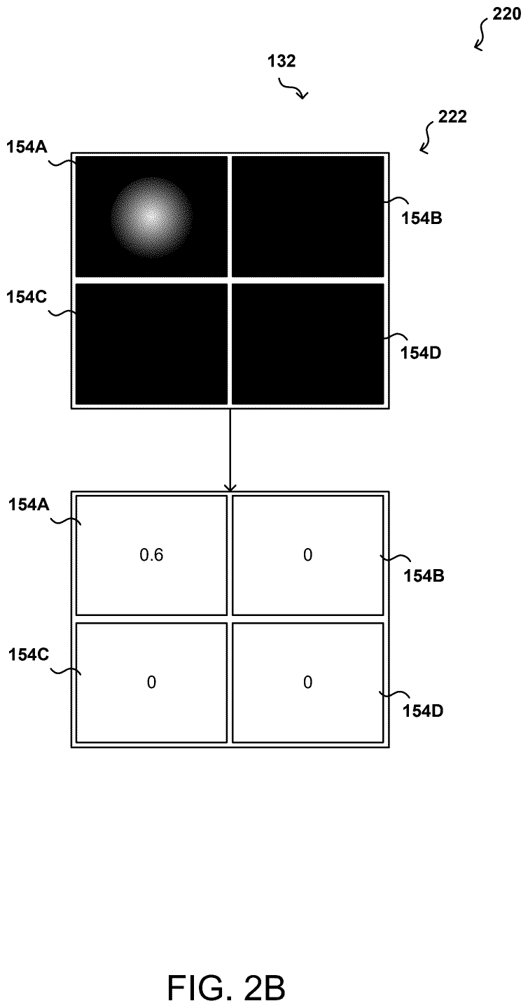

FIG. 2A illustrates an example environment 200 that may be used with embodiments of the present disclosure. In this example, the streaming system 102 may use a saliency mitigation system 202 to target one or more packet loss mitigation methods for use with particular packets and/or regions associated with the input frame 132. For example, targeted packet loss mitigation methods may be applied to portions of the input frame 132 determined to be important, which may be based on one or more saliency values. The input frame 132 may be evaluated by a saliency engine 204 to determine one or more portions of the input frame 132 that may include an important region and/or a content element that may be relevant for a viewing user. By way of example, if the input frame 132 was part of a video game, the salient regions may include regions where a health bar was displayed. As another example, if the input frame 132 was part of a sporting event, the relevant regions may include those where a ball or certain player was located.

Important or salient regions of the content associated with the input frame 132 may be any region of and/or element in the frame that is perceptually important, perceived by user to be significant or critical, or is designated as relevant by an application that generates the frame. The important or relevant regions may be regions of the frame that a user is more likely to focus on relative to other regions of the frame, for example due to movement within the frame or a desired attention point within the frame. Such regions may be selected for additional packet loss mitigation.

The saliency engine 204 may incorporate information from one or more map datastores 206 to determine saliency for a particular region. For example, the saliency maps may be generated by tracking user interactions with a particular content source, such as a video game. Users may provide permission for tracking, such as agreeing to eye-monitoring or mouse tracking, and saliency information may be based, at least in part, on the collected information to generate one or more saliency maps. The saliency maps may indicate regions of one or more frame that draw attention from a user or draw an interaction from a user. Additionally, in at least one embodiment, one or more deep learning techniques may be deployed to generate one or more saliency maps and/or to determine saliency for the input frame 132 in real or near-real time. For example, a classifier may be deployed to identify certain regions within the input frame 132 including one or more content elements deemed to be salient. As another example, optical flow information may be used to track movement within frames, which may be indicative of a salient region. In at least one embodiment, saliency maps may be updated over time, for example based on feedback from users.

Saliency maps may be generated for particular content, such as content that is intended to be streamed or is expected to be streamed. One non-limiting example includes computer gaming where a “triple A” title may be determined as being likely to have a high number of players, and as a result, may be evaluated to generate a frame-by-frame saliency map for the particular video game. As another example, the streaming service may determine, over a period of time, which titles are most popular and may then generate saliency maps for popular titles. In at least one embodiment, a publisher or developer may provide one or more saliency maps for their content, for example, based on a location where the publisher or developer intends for a user to look or interact as their interaction with the content progresses.

In at least one embodiment, the tile/slice engine 152 may be used to segment or otherwise divide the input frame 132 into different regions, as discussed herein. The regions may be of equal size or may be unequal in size. For example, for an input frame that has a substantially square shape, the regions may be equally sized quadrants. In another example, the regions may extend across a width of the input frame 132 (e.g., a horizontal slice) or along a height of the input frame 132 (e.g., a vertical tile). In one or more embodiments, the tile/slice engine 152 may receive information from the saliency engine 204 regarding the saliency maps and then divide or section the input frame 132 based on the saliency information. For example, one or more masks may be used to identify certain regions within the input frame 132 that are salient. By targeting certain smaller regions, the information within a given salient region may be better described and may, as noted herein, reduce bandwidth use because associated packet loss mitigation methods may be targeted to smaller regions.

A controller 208 may be used to determine how mitigation techniques are applied for a given input frame 132. The controller may be called a saliency-weighted controller in certain embodiments. For example, different regions of a frame may be evaluated to determine a saliency value for a particular region. The particular region may then be compared to other regions within the frame and, based on one or more metrics, a particular region may be deemed as being important for a given frame. As one example, each region may have a computed saliency score based on individual saliency values for pixels within the region. An average may then be computed for the saliency scores of the regions. If a region saliency score exceeds the average, then the region may be deemed important. In at least one embodiment, a threshold may be used such that a region having a saliency that is below a threshold saliency value will not receive one or more mitigation methods. In another example, respective saliency values for each region within the input frame 132 may be compared. In another example, a certain number or percentage of the regions with the highest saliency values may be selected. Additionally, other selection methods may be used. In one or more embodiments, the controller 208 may determine that no mitigation methods are to be applied, for example for frames with a low saliency, such as a loading screen.

Various embodiments may deploy one or more packet loss mitigation methods, which may also be referred to as error correction methods and/or packet duplication methods. For example, FEC may be one method applied to different portions of frames. As another example, packet duplication may be used such that certain packets may be duplicated during transmission. Sending multiple copies of a packet may reduce a likelihood that the packet is lost because each copy would need to be lost to lead to an outcome where the packet is declared lost. Additionally, in at least one embodiment, both FEC and duplication, or any other methods, may be applied at the same time or to different regions. For example, a particularly important region may include both duplication and FEC. As another example, one region may receive duplication and another may receive FEC. Accordingly, systems and methods may determine which error correction methods to use based, at least in part, on an importance of portions of the input frame 132.

The group of network packets 134, is further illustrated in FIG. 2A and includes different regions 154A-154D and one or more different mitigation methods 212A-212D, which may include associated correction data or duplication of packets. As discussed, the mitigation methods 212A-212D may or may not be applied to the different regions 154A-154D based, at least in part, on an evaluation of the importance of the different regions. In certain examples, multiple methods may be applied to a single region and/or a region may include no methods. Furthermore, different methods may be applied for different regions, and may be based on a saliency score. For example, it may be determined that duplication is a preferred method and higher importance regions may use duplication instead of FEC. Accordingly, systems and methods may be used to selectively apply correction methods to different regions 154 of the input frame 132. Furthermore, in at least one embodiment, an amount of the method to apply to each region 154 may be based on the importance of the region 154. For example, different percentages of FEC or duplication may be applied based on the importance of the different regions 154.

FIG. 2B illustrates an example environment 220 that may be used with embodiments of the present disclosure. In this example, a saliency map 222 is provided for the input frame 132. The saliency map 222 may include values for individual pixels forming the input frame 132. The input frame 132 in this example is divided into the regions 154A-154D. The darker regions illustrate a low saliency value and the lighter regions illustrate a higher saliency value. A region saliency score may be computed as an average of the saliency values for individual pixels within the region. Accordingly, the saliency scores for the regions 154B-154D are approximately zero. However, because the saliency values in the region 154A have some high value pixels and other low value pixels, the saliency score for this region is greater than zero and is shown as 0.6 as a non-limiting example. For the frame, an average saliency score may be determined. In this example, there are four regions with saliency scores of 0.6, 0, 0, and 0. As a result, the average saliency score for the frame is 0.15. In at least one embodiment, a region may be an important region if it has a saliency score that exceeds the average computed for the frame. In this example, 0.6 exceeds the 0.15 average, and therefore, the region 154A is important.

It should be appreciated that other methods may be used to determine importance for a region. For example, a threshold or lower level saliency score may be set for a given frame and each frame exceeding that value may be important. As another example, a certain percentage of frames exceeding the average saliency score, or some threshold may be considered important. Accordingly, systems and methods may deploy a variety of different ways to determine importance and the selection of the determination method may be based on one or more parameters, such as network configuration settings, device settings, content type, and/or the like.

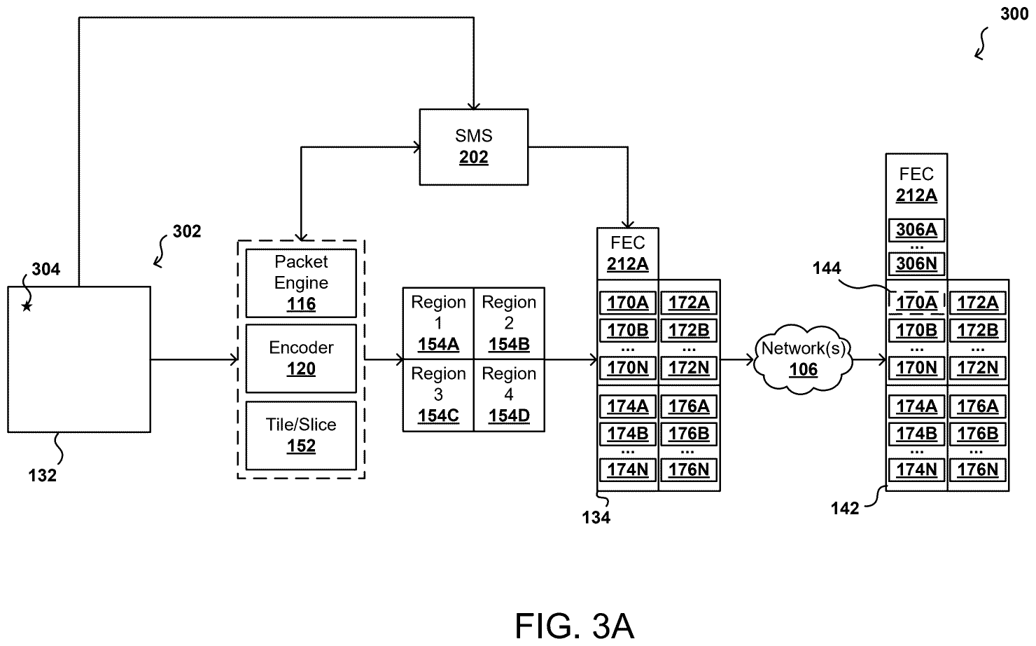

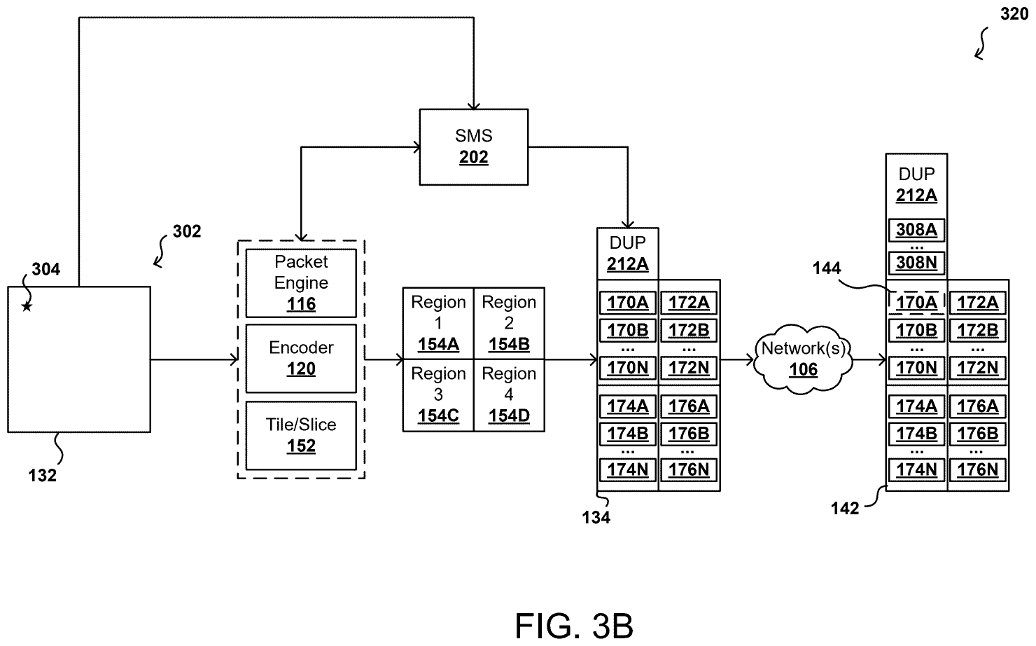

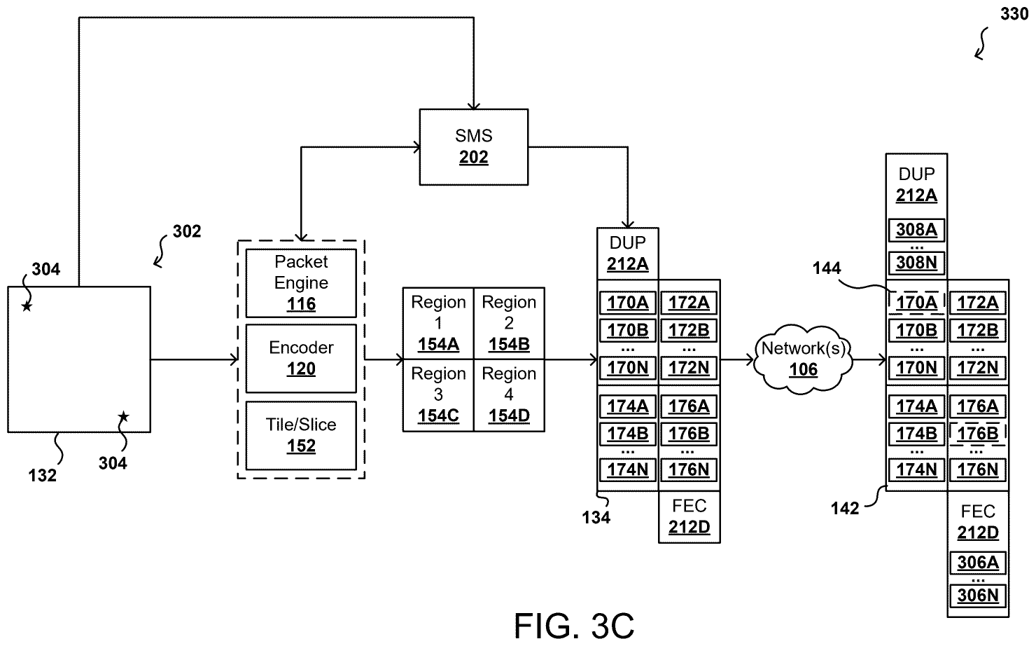

FIG. 3A illustrates an example environment 300 that may be used with embodiments of the present disclosure. A data transmission application is illustrated that applies selective correction based on importance. The input frame 132 is illustrated for transmission across one or more networks 106. An input frame representation 302 includes a salient element 304, which in this non-limiting example is shown within an upper left quadrant of the representation 302.

The input frame 132 is then segmented into a number of regions or tiles 154A-154D. As discussed herein, the regions 154A-154D may not be the same size in all applications. Moreover, the regions 154A-154D may be provided in a variety of configurations, including all horizontal, all vertical, combinations of vertical and horizontal, and the like. Additionally, regions may be selected based on the salient elements 304. For example, a smaller, particularized region may be established when one or more salient elements 304 are detected. In this example, the saliency mitigation system 202 may be used to identify the salient element 304, for example based on one or more saliency maps, which may be used to generate the different regions 154A-154D.

In at least one embodiment, the regions 154A-154D may be evaluated by the controller 208 of the saliency mitigation system 202 to determine which regions 154A-154D, if any, will use one or more packet loss mitigation methods. For example, saliency may be determined based on an assigned value and/or a comparison to one or more other regions 154A-154D. Regions 154A-154D with saliency values that exceed a threshold value (e.g., exceed an average saliency for the entire frame) may then be packaged with one or more mitigation methods 212. In the illustrated embodiment, the mitigation corresponds to error correction incorporating FEC.

Furthermore, in at least one embodiment, a level or quantity of mitigation applied may be based on the saliency value of the region, a number of regions receiving correction, and/or the like. For example, a region may be deemed to be important based on a comparison to other regions of the frame, but may have a saliency value that is less than some other threshold, and therefore, may only receive a percentage or portion of the correction. For example, the FEC 212A in FIG. 3A may be at fifty percent. That is, any number of lost or corrupted packets up to k/2 may receive the correction, where k equals the total number of packets 170A-170N for the region 154A. In other embodiments, if the first region 154A had a higher saliency value, the applied correction may be greater. Additionally, if the first region 154A had a lower saliency value, but still was deemed important, the applied mitigation, which in this example is FEC, may be lower.

The received network packet 142 is shown as having the lost packet 144 corresponding to the packet 170A in the region 154A. Because the region 154A had the mitigation 212A applied, one or more algorithms may be used to correct or replace the lost packet. For example, error correction packets 306A-306N may be used to reconstruct the packets associated with the region 154A, thereby permitting decoding and rendering at the intended quality.

FIG. 3B illustrates an example environment 320 that may be used with embodiments of the present disclosure. The environment 320 shares numerous features with the environment 300, but in this example, the mitigation applied by the saliency mitigation system 202 is to duplicate one or more of the packets 170A-170N for the region 154A, instead of applying FEC. As discussed herein, the quantity of duplication may be based on a variety of factors such that only a portion of the packets 170A-170N in the region 154A may be sent more than once. As a result, duplicate packets 308A-308N may include any reasonable number of packets to duplicate one or more of the packets 170A-170N.

FIG. 3C illustrates an example environment 330 that may be used with embodiments of the present disclosure. The environment 330 shares numerous features with the environments 300, 320, but in this example, the mitigation applied by the saliency mitigation system 202 is to duplicate one or more of the packets 170A-170N for the region 154A and to apply FEC to one or more of the packets 176A-176N for the region 154D. Accordingly, systems and methods of the present disclosure may mix and apply different methods for packet loss mitigation based on operations parameters and/or saliency of regions of the input frame 132.

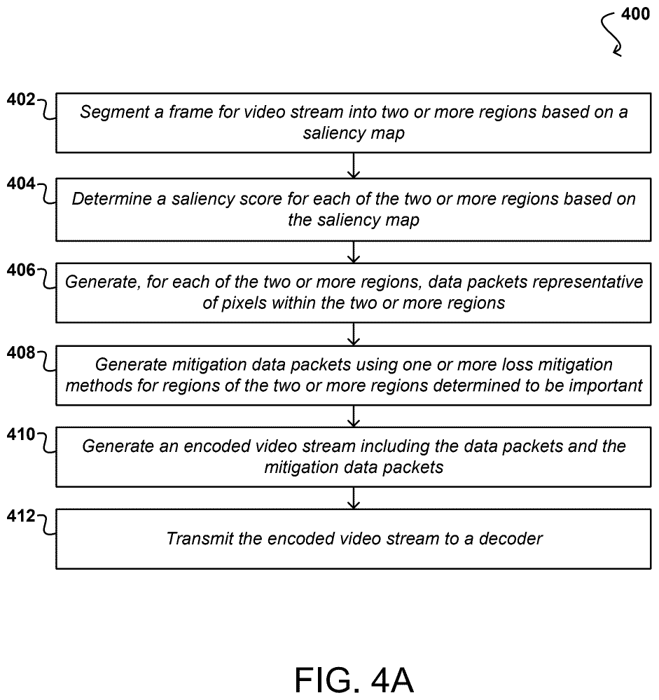

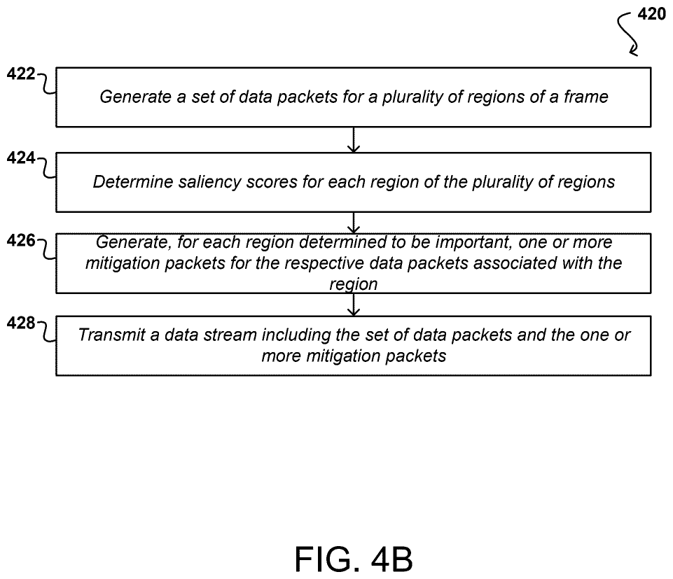

FIG. 4A illustrates an example flow chart for an example process 400 to apply error correction to one or more frames in a video stream. It should be understood that for this and other processes presented herein that there can be additional, fewer, or alternative operations performed in similar or alternative order, or at least partially in parallel, within the scope of various embodiments unless otherwise specifically stated. In this example, a frame for a video stream is segmented into two or more regions 402. In at least one embodiment, a saliency map is used to specify how to segment the frame into the two or more regions. The segmentation may include tiling the frame into equal regions, splitting the frame into horizontal strips, splitting the frame into vertical strips, or any other region splitting.

In at least one embodiment, a saliency value may be determined for each of the two or more regions based on the saliency map 404. The saliency map may be a per-frame saliency map and may be generated using one or more techniques, such as eye tracking, deep learning methods, or others. The saliency map may be used to identify important regions within a frame, such as regions where a user is more likely to focus or interact with content elements in the frame. Each pixel within the frame may have a value. For a given region, a region saliency score may be an average of the saliency values of the pixels within the region. A saliency score may be a normalized score. Data packets may be generated representative of the pixels within the two or more regions 406. For example, the data packets may be part of an encoded video stream to transmit the frame across one or more networks.

Mitigation data packets may be generated using one or more loss mitigation methods 408. The mitigation data packets may be associated with particular regions where the saliency score was sufficient to designate the region as being important. Systems and methods may include one or more approaches for determining whether a region is important. As one example, an average saliency score for the frame may be computed based on individual region saliency scores. A region having a region saliency score higher than the average saliency score for the frame may be deemed important. As another example, a threshold value may be established to determine whether a region has a region saliency score that is deemed important enough for mitigation. As another example, each of the regions may be compared against one another and a region having the highest score may be deemed the most important. An encoded video stream may be generated to include both the data packets and the mitigation data packets 410 and may be transmitted to a decoder 412. In this manner, mitigation methods may be selectively applied to certain regions of the frame based on the saliency of the region.

FIG. 4B illustrates an example flow chart for an example process 420 to generate mitigation packets for a video stream based on salient regions of a frame. In this example, a set of data packets may be generated for a plurality of regions of a frame 422. Saliency scores (e.g., saliency values) may be determined for each region of the plurality of regions 424. For example, a saliency map may be used to determine saliency values for pixels within a region. Additionally, as discussed herein, one or more region evaluations may be used to determine saliency values and/or assign (identify, indicate, represent, etc.) an importance to particular regions of the plurality of regions. For each region with a saliency score indicative of being an important region, one or more mitigation packets for the associated data packets for the important regions may be generated 426. The mitigation packets may be associated with one or more methods for packet loss mitigation, such as duplication and/or FEC. A data stream may then be transmitted to include the set of data packets and the one or more mitigation packets 428.

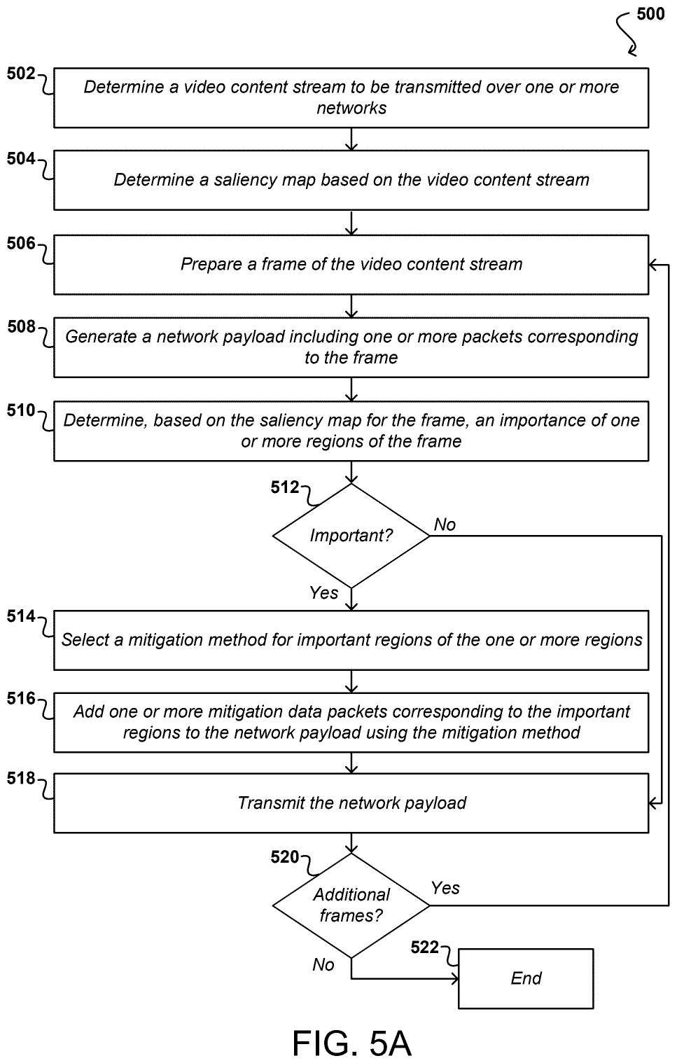

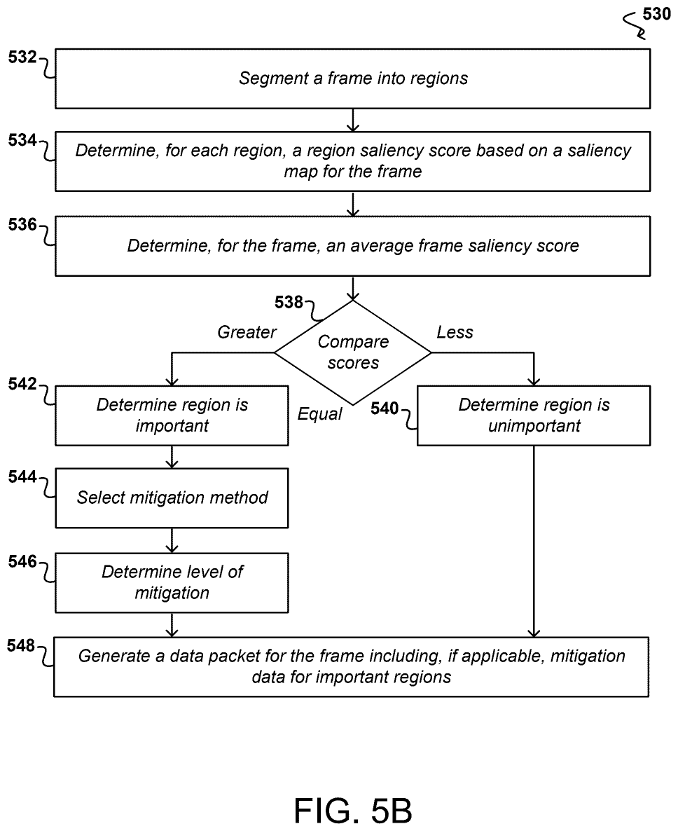

FIG. 5A illustrates an example flow chart for an example process 500 to select one or more network packets and generate mitigation packets for them. In this example, a video content stream to be transmitted over one or more networks is determined 502. For example, a user may submit a request to transmit video content, such as a video game or other types of content. A saliency map may be determined for the video content stream 504. In at least one embodiment, the saliency map may be retrieved from a storage location, such as a database, and may be used on a per-frame basis. In various other embodiments, the same saliency map may be used for a number of frames, for example, for every five frames. Additionally, various embodiments may also generate the saliency map in real or near-real time, such as by using one or more deep learning techniques to evaluate content with the frame and determine one or more regions or content elements that are deemed important.

In at least one embodiment, a frame for the video content stream is prepared 506 and a network payload including one or more packets associated with the frame may be generated 508. The frame may be evaluated to determine an importance of one or more regions of the frame using the saliency map 510. For example, the frame may be tiled or segmented and then different regions may be evaluated, using the saliency map, to determine whether one or more regions is an important region. As discussed herein, importance may be based on a variety of factors, such as a threshold value, a comparison against other regions, and/or the like.

It may be determined whether the one or more regions of the frame are determined to be important 512. If so, then a mitigation method may be selected for the important one or more regions 514. The mitigation method may also be used to generate one or more mitigation data packets, corresponding to regions identified as important regions, that may be added to the network payload 516. The network payload may then be transmitted 518. In at least one embodiment, a single network packet sequence is transmitted for a single frame, but it should be appreciated that in various other embodiments multiple frames may be included within a single network packet sequence. It may then be determined whether there are additional frames for evaluation 520. The process may repeat until all of the frames for the video content element have been evaluated, packetized, and transmitted, and if no more frames are available, the process may end 522.

FIG. 5B illustrates an example flow chart for an example process 530 to generate data packets for content transmission over one or more networks. In this example, a frame is segmented into regions 532. For example, the frame may be an input frame for a video sequence and the segmenting may include slicing or tiling the frame. In at least one embodiment, a region saliency score is determined for each region of the frame 534. The score may be based on a saliency map for the frame, where at least one (e.g., each) region includes a number of pixels with respective saliency value. The region saliency score, in certain embodiments, may be equal to an average saliency of one or more (e.g., each) of the pixel saliency values within the region.

In at least one embodiment, an average frame saliency score may be determined for the frame 536. The average frame saliency score may be equal to an average of each of the saliency scores for each of the regions forming the frame. The scores may then be compared for each of the regions with respect to the average frame saliency score 538. If a particular region saliency score is less than the average frame saliency score, then the region may be determined to be unimportant 540. If a particular region saliency score is greater than the average frame saliency score, then the region may be determined to be important 542. For important regions, a mitigation method may be selected 544. The mitigation method may be associated with packet loss mitigation methods, such as FEC or duplication, among other options. A level of mitigation may also be determined 546. For example, different percentages or levels may be deployed based on bandwidth availability, importance, and/or the like. A data packet may then be generated for the frame, which may include mitigation data associated with the mitigation method for the important regions 548. In this manner, only certain important regions may be selected for packet loss mitigation methods, thereby decreasing compute costs and bandwidth use.

As discussed, aspects of various approaches presented herein can be lightweight enough to execute on a device such as a client device, such as a personal computer or gaming console, in real time. Such processing can be performed on, or for, content that is generated on, or received by, that client device or received from an external source, such as streaming data or other content received over at least one network. In some instances, the processing and/or determination of this content may be performed by one of these other devices, systems, or entities, then provided to the client device (or another such recipient) for presentation or another such use.

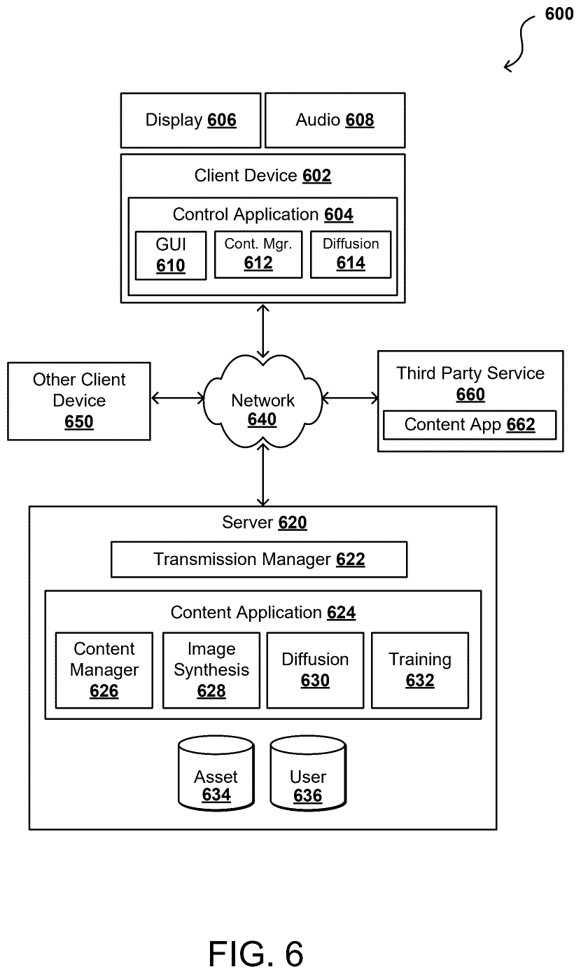

As an example, FIG. 6 illustrates an example network configuration 600 that can be used to provide, generate, modify, encode, process, and/or transmit image data or other such content. In at least one embodiment, a client device 602 can generate or receive data for a session using components of a control application 604 on client device 602 and data stored locally on that client device. In at least one embodiment, a content application 624 executing on a server 620 (e.g., a cloud server or edge server) may initiate a session associated with at least one client device 602, as may utilize a session manager and user data stored in a user database 636, and can cause content such as one or more digital assets (e.g., object representations) from an asset repository 634 to be determined by a content manager 626. A content manager 626 may work with an image synthesis module 628 to generate or synthesize new objects, digital assets, or other such content to be provided for presentation via the client device 602. In at least one embodiment, this image synthesis module 628 can use one or more neural networks, or machine learning models, which can be trained or updated using a training module 632 or system that is on, or in communication with, the server 620. This can include training and/or using a diffusion model 630 to generate content tiles that can be used by an image synthesis module 628, for example, to apply a non-repeating texture to a region of an environment for which image or video data is to be presented via a client device 602. At least a portion of the generated content may be transmitted to the client device 602 using an appropriate transmission manager 622 to send by download, streaming, or another such transmission channel. An encoder may be used to encode and/or compress at least some of this data before transmitting to the client device 602. In at least one embodiment, the client device 602 receiving such content can provide this content to a corresponding control application 604, which may also or alternatively include a graphical user interface 610, content manager 612, and image synthesis or diffusion module 614 for use in providing, synthesizing, modifying, or using content for presentation (or other purposes) on or by the client device 602. A decoder may also be used to decode data received over the network(s) 640 for presentation via client device 602, such as image or video content through a display 606 and audio, such as sounds and music, through at least one audio playback device 608, such as speakers or headphones. In at least one embodiment, at least some of this content may already be stored on, rendered on, or accessible to client device 602 such that transmission over network 640 is not required for at least that portion of content, such as where that content may have been previously downloaded or stored locally on a hard drive or optical disk. In at least one embodiment, a transmission mechanism such as data streaming can be used to transfer this content from server 620, or user database 636, to client device 602. In at least one embodiment, at least a portion of this content can be obtained, enhanced, and/or streamed from another source, such as a third party service 660 or other client device 650, that may also include a content application 662 for generating, enhancing, or providing content. In at least one embodiment, portions of this functionality can be performed using multiple computing devices, or multiple processors within one or more computing devices, such as may include a combination of CPUs and GPUs.

In this example, these client devices can include any appropriate computing devices, as may include a desktop computer, notebook computer, set-top box, streaming device, gaming console, smartphone, tablet computer, VR headset, AR goggles, wearable computer, or a smart television. Each client device can submit a request across at least one wired or wireless network, as may include the Internet, an Ethernet, a local area network (LAN), or a cellular network, among other such options. In this example, these requests can be submitted to an address associated with a cloud provider, who may operate or control one or more electronic resources in a cloud provider environment, such as may include a data center or server farm. In at least one embodiment, the request may be received or processed by at least one edge server, that sits on a network edge and is outside at least one security layer associated with the cloud provider environment. In this way, latency can be reduced by enabling the client devices to interact with servers that are in closer proximity, while also improving security of resources in the cloud provider environment.

In at least one embodiment, such a system can be used for performing graphical rendering operations. In other embodiments, such a system can be used for other purposes, such as for providing image or video content to test or validate autonomous machine applications, or for performing deep learning operations. In at least one embodiment, such a system can be implemented using an edge device, or may incorporate one or more Virtual Machines (VMs). In at least one embodiment, such a system can be implemented at least partially in a data center or at least partially using cloud computing resources.

### Inference and Training Logic

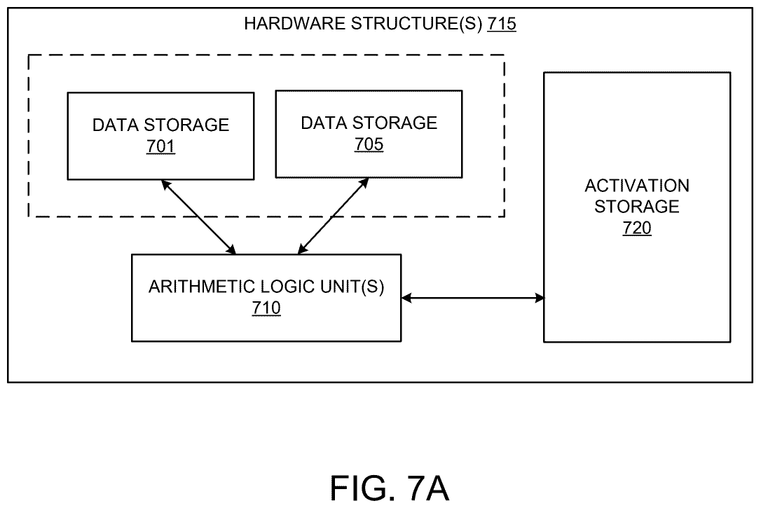

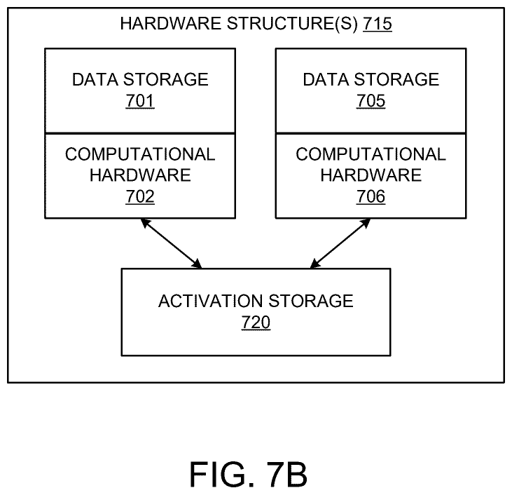

FIG. 7A illustrates inference and/or training logic 715 used to perform inferencing and/or training operations associated with one or more embodiments. Details regarding inference and/or training logic 715 are provided below in conjunction with FIGS. 7A and/or 7B.

In at least one embodiment, inference and/or training logic 715 may include, without limitation, code and/or data storage 701 to store forward and/or output weight and/or input/output data, and/or other parameters to configure neurons or layers of a neural network trained and/or used for inferencing in aspects of one or more embodiments. In at least one embodiment, training logic 715 may include, or be coupled to code and/or data storage 701 to store graph code or other software to control timing and/or order, in which weight and/or other parameter information is to be loaded to configure, logic, including integer and/or floating point units (collectively, arithmetic logic units (ALUs). In at least one embodiment, code, such as graph code, loads weight or other parameter information into processor ALUs based on an architecture of a neural network to which the code corresponds. In at least one embodiment, code and/or data storage 701 stores weight parameters and/or input/output data of each layer of a neural network trained or used in conjunction with one or more embodiments during forward propagation of input/output data and/or weight parameters during training and/or inferencing using aspects of one or more embodiments. In at least one embodiment, any portion of code and/or data storage 701 may be included with other on-chip or off-chip data storage, including a processor's L1, L2, or L3 cache or system memory.

In at least one embodiment, any portion of code and/or data storage 701 may be internal or external to one or more processors or other hardware logic devices or circuits. In at least one embodiment, code and/or data storage 701 may be cache memory, dynamic randomly addressable memory (“DRAM”), static randomly addressable memory (“SRAM”), non-volatile memory (e.g., Flash memory), or other storage. In at least one embodiment, choice of whether code and/or data storage 701 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors.

In at least one embodiment, inference and/or training logic 715 may include, without limitation, a code and/or data storage 705 to store backward and/or output weight and/or input/output data corresponding to neurons or layers of a neural network trained and/or used for inferencing in aspects of one or more embodiments. In at least one embodiment, code and/or data storage 705 stores weight parameters and/or input/output data of each layer of a neural network trained or used in conjunction with one or more embodiments during backward propagation of input/output data and/or weight parameters during training and/or inferencing using aspects of one or more embodiments. In at least one embodiment, training logic 715 may include, or be coupled to code and/or data storage 705 to store graph code or other software to control timing and/or order, in which weight and/or other parameter information is to be loaded to configure, logic, including integer and/or floating point units (collectively, arithmetic logic units (ALUs). In at least one embodiment, code, such as graph code, loads weight or other parameter information into processor ALUs based on an architecture of a neural network to which the code corresponds. In at least one embodiment, any portion of code and/or data storage 705 may be included with other on-chip or off-chip data storage, including a processor's L1, L2, or L3 cache or system memory. In at least one embodiment, any portion of code and/or data storage 705 may be internal or external to on one or more processors or other hardware logic devices or circuits. In at least one embodiment, code and/or data storage 705 may be cache memory, DRAM, SRAM, non-volatile memory (e.g., Flash memory), or other storage. In at least one embodiment, choice of whether code and/or data storage 705 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors.

In at least one embodiment, code and/or data storage 701 and code and/or data storage 705 may be separate storage structures. In at least one embodiment, code and/or data storage 701 and code and/or data storage 705 may be same storage structure. In at least one embodiment, code and/or data storage 701 and code and/or data storage 705 may be partially same storage structure and partially separate storage structures. In at least one embodiment, any portion of code and/or data storage 701 and code and/or data storage 705 may be included with other on-chip or off-chip data storage, including a processor's L1, L2, or L3 cache or system memory.

In at least one embodiment, inference and/or training logic 715 may include, without limitation, one or more arithmetic logic unit(s) (“ALU(s)”) 710, including integer and/or floating point units, to perform logical and/or mathematical operations based, at least in part on, or indicated by, training and/or inference code (e.g., graph code), a result of which may produce activations (e.g., output values from layers or neurons within a neural network) stored in an activation storage 720 that are functions of input/output and/or weight parameter data stored in code and/or data storage 701 and/or code and/or data storage 705. In at least one embodiment, activations stored in activation storage 720 are generated according to linear algebraic and or matrix-based mathematics performed by ALU(s) 710 in response to performing instructions or other code, wherein weight values stored in code and/or data storage 705 and/or code and/or data storage 701 are used as operands along with other values, such as bias values, gradient information, momentum values, or other parameters or hyperparameters, any or all of which may be stored in code and/or data storage 705 or code and/or data storage 701 or another storage on or off-chip.

In at least one embodiment, ALU(s) 710 are included within one or more processors or other hardware logic devices or circuits, whereas in another embodiment, ALU(s) 710 may be external to a processor or other hardware logic device or circuit that uses them (e.g., a co-processor). In at least one embodiment, ALU(s) 710 may be included within a processor's execution units or otherwise within a bank of ALUs accessible by a processor's execution units either within same processor or distributed between different processors of different types (e.g., central processing units, graphics processing units, fixed function units, etc.). In at least one embodiment, code and/or data storage 701, code and/or data storage 705, and activation storage 720 may be on same processor or other hardware logic device or circuit, whereas in another embodiment, they may be in different processors or other hardware logic devices or circuits, or some combination of same and different processors or other hardware logic devices or circuits. In at least one embodiment, any portion of activation storage 720 may be included with other on-chip or off-chip data storage, including a processor's L1, L2, or L3 cache or system memory. Furthermore, inferencing and/or training code may be stored with other code accessible to a processor or other hardware logic or circuit and fetched and/or processed using a processor's fetch, decode, scheduling, execution, retirement and/or other logical circuits.

In at least one embodiment, activation storage 720 may be cache memory, DRAM, SRAM, non-volatile memory (e.g., Flash memory), or other storage. In at least one embodiment, activation storage 720 may be completely or partially within or external to one or more processors or other logical circuits. In at least one embodiment, choice of whether activation storage 720 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors. In at least one embodiment, inference and/or training logic 715 illustrated in FIG. 7A may be used in conjunction with an application-specific integrated circuit (“ASIC”), such as Tensorflow® Processing Unit from Google, an inference processing unit (IPU) from Graphcore™, or a Nervana® (e.g., “Lake Crest”) processor from Intel Corp. In at least one embodiment, inference and/or training logic 715 illustrated in FIG. 7A may be used in conjunction with central processing unit (“CPU”) hardware, graphics processing unit (“GPU”) hardware or other hardware, such as field programmable gate arrays (“FPGAs”).

FIG. 7B illustrates inference and/or training logic 715, according to at least one or more embodiments. In at least one embodiment, inference and/or training logic 715 may include, without limitation, hardware logic in which computational resources are dedicated or otherwise exclusively used in conjunction with weight values or other information corresponding to one or more layers of neurons within a neural network. In at least one embodiment, inference and/or training logic 715 illustrated in FIG. 7B may be used in conjunction with an application-specific integrated circuit (ASIC), such as Tensorflow® Processing Unit from Google, an inference processing unit (IPU) from Graphcore™, or a Nervana® (e.g., “Lake Crest”) processor from Intel Corp. In at least one embodiment, inference and/or training logic 715 illustrated in FIG. 7B may be used in conjunction with central processing unit (CPU) hardware, graphics processing unit (GPU) hardware or other hardware, such as field programmable gate arrays (FPGAs). In at least one embodiment, inference and/or training logic 715 includes, without limitation, code and/or data storage 701 and code and/or data storage 705, which may be used to store code (e.g., graph code), weight values and/or other information, including bias values, gradient information, momentum values, and/or other parameter or hyperparameter information. In at least one embodiment illustrated in FIG. 7B, each of code and/or data storage 701 and code and/or data storage 705 is associated with a dedicated computational resource, such as computational hardware 702 and computational hardware 706, respectively. In at least one embodiment, each of computational hardware 702 and computational hardware 706 comprises one or more ALUs that perform mathematical functions, such as linear algebraic functions, only on information stored in code and/or data storage 701 and code and/or data storage 705, respectively, result of which is stored in activation storage 720.

In at least one embodiment, each of code and/or data storage 701 and 705 and corresponding computational hardware 702 and 706, respectively, correspond to different layers of a neural network, such that resulting activation from one “storage/computational pair 701/702” of code and/or data storage 701 and computational hardware 702 is provided as an input to “storage/computational pair 705/706” of code and/or data storage 705 and computational hardware 706, in order to mirror conceptual organization of a neural network. In at least one embodiment, each of storage/computational pairs 701/702 and 705/706 may correspond to more than one neural network layer. In at least one embodiment, additional storage/computation pairs (not shown) subsequent to or in parallel with storage computation pairs 701/702 and 705/706 may be included in inference and/or training logic 715.

### Data Center

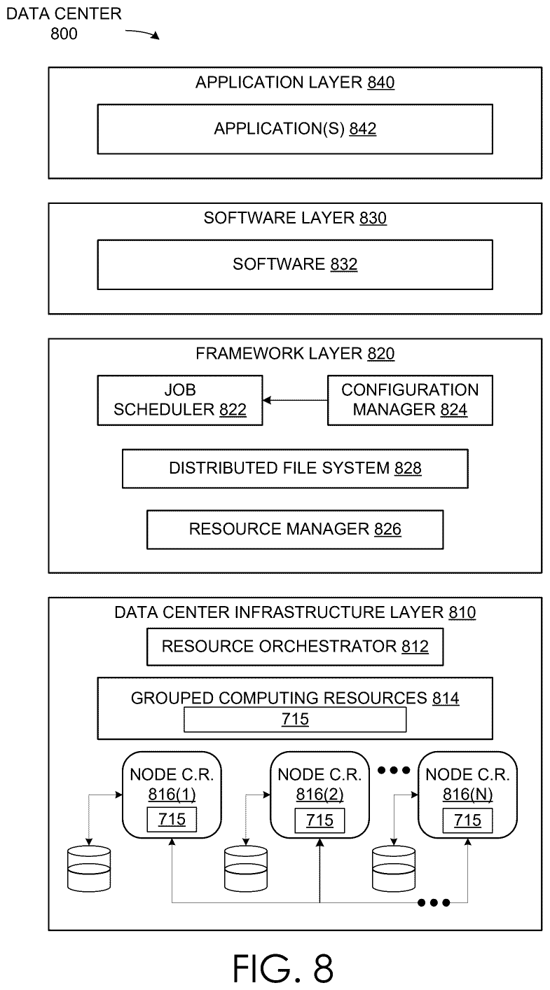

FIG. 8 illustrates an example data center 800, in which at least one embodiment may be used. In at least one embodiment, data center 800 includes a data center infrastructure layer 810, a framework layer 820, a software layer 830, and an application layer 840.

In at least one embodiment, as shown in FIG. 8, data center infrastructure layer 810 may include a resource orchestrator 812, grouped computing resources 814, and node computing resources (“node C.R.s”) 816(1)-816(N), where “N” represents any whole, positive integer. In at least one embodiment, node C.R.s 816(1)-816(N) may include, but are not limited to, any number of central processing units (“CPUs”) or other processors (including accelerators, field programmable gate arrays (FPGAs), graphics processors, etc.), memory devices (e.g., dynamic read-only memory), storage devices (e.g., solid state or disk drives), network input/output (“NW I/O”) devices, network switches, virtual machines (“VMs”), power modules, and cooling modules, etc. In at least one embodiment, one or more node C.R.s from among node C.R.s 816(1)-816(N) may be a server having one or more of above-mentioned computing resources.

In at least one embodiment, grouped computing resources 814 may include separate groupings of node C.R.s housed within one or more racks (not shown), or many racks housed in data centers at various geographical locations (also not shown). Separate groupings of node C.R.s within grouped computing resources 814 may include grouped compute, network, memory or storage resources that may be configured or allocated to support one or more workloads. In at least one embodiment, several node C.R.s including CPUs or processors may be grouped within one or more racks to provide compute resources to support one or more workloads. In at least one embodiment, one or more racks may also include any number of power modules, cooling modules, and network switches, in any combination.

In at least one embodiment, resource orchestrator 812 may configure or otherwise control one or more node C.R.s 816(1)-816(N) and/or grouped computing resources 814. In at least one embodiment, resource orchestrator 812 may include a software design infrastructure (“SDI”) management entity for data center 800. In at least one embodiment, resource orchestrator 812 may include hardware, software or some combination thereof.

In at least one embodiment, as shown in FIG. 8, framework layer 820 includes a job scheduler 822, a configuration manager 824, a resource manager 826 and a distributed file system 828. In at least one embodiment, framework layer 820 may include a framework to support software 832 of software layer 830 and/or one or more application(s) 842 of application layer 840. In at least one embodiment, software 832 or application(s) 842 may respectively include web-based service software or applications, such as those provided by Amazon Web Services, Google Cloud and Microsoft Azure. In at least one embodiment, framework layer 820 may be, but is not limited to, a type of free and open-source software web application framework such as Apache Spark™ (hereinafter “Spark”) that may use distributed file system 828 for large-scale data processing (e.g., “big data”). In at least one embodiment, job scheduler 822 may include a Spark driver to facilitate scheduling of workloads supported by various layers of data center 800. In at least one embodiment, configuration manager 824 may be capable of configuring different layers such as software layer 830 and framework layer 820 including Spark and distributed file system 828 for supporting large-scale data processing. In at least one embodiment, resource manager 826 may be capable of managing clustered or grouped computing resources mapped to or allocated for support of distributed file system 828 and job scheduler 822. In at least one embodiment, clustered or grouped computing resources may include grouped computing resource 814 at data center infrastructure layer 810. In at least one embodiment, resource manager 826 may coordinate with resource orchestrator 812 to manage these mapped or allocated computing resources.

In at least one embodiment, software 832 included in software layer 830 may include software used by at least portions of node C.R.s 816(1)-816(N), grouped computing resources 814, and/or distributed file system 828 of framework layer 820. The one or more types of software may include, but are not limited to, Internet web page search software, e-mail virus scan software, database software, and streaming video content software.

In at least one embodiment, application(s) 842 included in application layer 840 may include one or more types of applications used by at least portions of node C.R.s 816(1)-816(N), grouped computing resources 814, and/or distributed file system 828 of framework layer 820. One or more types of applications may include, but are not limited to, any number of a genomics application, a cognitive compute, and a machine learning application, including training or inferencing software, machine learning framework software (e.g., PyTorch, TensorFlow, Caffe, etc.) or other machine learning applications used in conjunction with one or more embodiments.

In at least one embodiment, any of configuration manager 824, resource manager 826, and resource orchestrator 812 may implement any number and type of self-modifying actions based on any amount and type of data acquired in any technically feasible fashion. In at least one embodiment, self-modifying actions may relieve a data center operator of data center 800 from making possibly bad configuration decisions and possibly avoiding underused and/or poor performing portions of a data center.

In at least one embodiment, data center 800 may include tools, services, software or other resources to train one or more machine learning models or predict or infer information using one or more machine learning models according to one or more embodiments described herein. For example, in at least one embodiment, a machine learning model may be trained by calculating weight parameters according to a neural network architecture using software and computing resources described above with respect to data center 800. In at least one embodiment, trained machine learning models corresponding to one or more neural networks may be used to infer or predict information using resources described above with respect to data center 800 by using weight parameters calculated through one or more training techniques described herein.

In at least one embodiment, data center may use CPUs, application-specific integrated circuits (ASICs), GPUs, FPGAs, or other hardware to perform training and/or inferencing using above-described resources. Moreover, one or more software and/or hardware resources described above may be configured as a service to allow users to train or performing inferencing of information, such as image recognition, speech recognition, or other artificial intelligence services.

Inference and/or training logic 715 are used to perform inferencing and/or training operations associated with one or more embodiments. Details regarding inference and/or training logic 715 are provided below in conjunction with FIGS. 7A and/or 7B. In at least one embodiment, inference and/or training logic 715 may be used in system FIG. 8 for inferencing or predicting operations based, at least in part, on weight parameters calculated using neural network training operations, neural network functions and/or architectures, or neural network use cases described herein.

Such components can be used for packet loss mitigation.

### Computer Systems

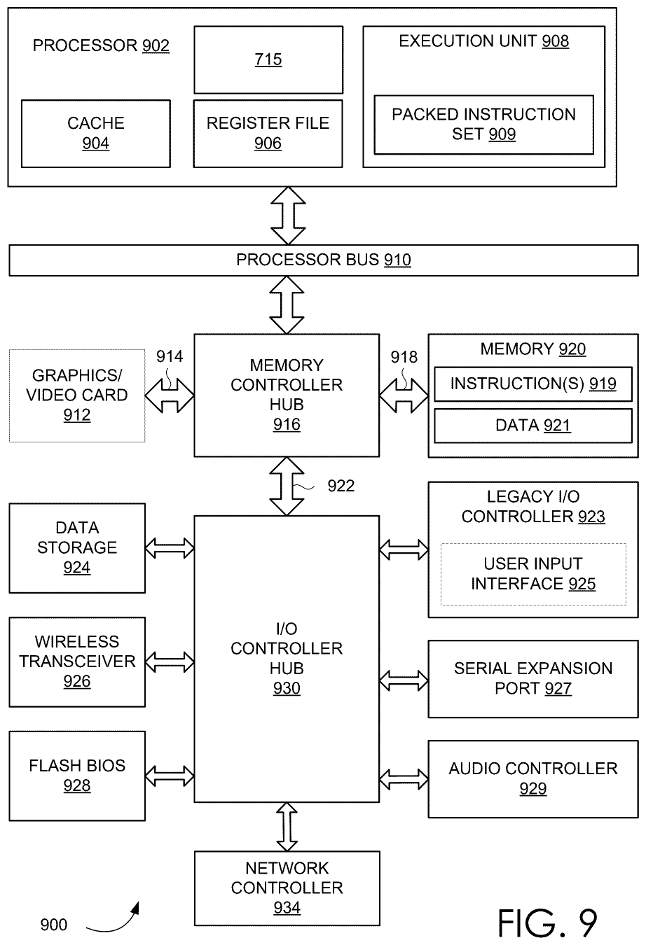

FIG. 9 is a block diagram illustrating an exemplary computer system, which may be a system with interconnected devices and components, a system-on-a-chip (SOC) or some combination thereof 900 formed with a processor that may include execution units to execute an instruction, according to at least one embodiment. In at least one embodiment, computer system 900 may include, without limitation, a component, such as a processor 902 to employ execution units including logic to perform algorithms for process data, in accordance with present disclosure, such as in embodiment described herein. In at least one embodiment, computer system 900 may include processors, such as PENTIUM® Processor family, Xeon™, Itanium®, XScale™ and/or StrongARM™, Intel® Core™, or Intel® Nervana™ microprocessors available from Intel Corporation of Santa Clara, California, although other systems (including PCs having other microprocessors, engineering workstations, set-top boxes and like) may also be used. In at least one embodiment, computer system 900 may execute a version of WINDOWS' operating system available from Microsoft Corporation of Redmond, Wash., although other operating systems (UNIX and Linux for example), embedded software, and/or graphical user interfaces, may also be used.

Embodiments may be used in other devices such as handheld devices and embedded applications. Some examples of handheld devices include cellular phones, Internet Protocol devices, digital cameras, personal digital assistants (“PDAs”), and handheld PCs. In at least one embodiment, embedded applications may include a microcontroller, a digital signal processor (“DSP”), system on a chip, network computers (“NetPCs”), set-top boxes, network hubs, wide area network (“WAN”) switches, or any other system that may perform one or more instructions in accordance with at least one embodiment.

In at least one embodiment, computer system 900 may include, without limitation, processor 902 that may include, without limitation, one or more execution units 908 to perform machine learning model training and/or inferencing according to techniques described herein. In at least one embodiment, computer system 900 is a single processor desktop or server system, but in another embodiment computer system 900 may be a multiprocessor system. In at least one embodiment, processor 902 may include, without limitation, a complex instruction set computing (“CISC”) microprocessor, a reduced instruction set computing (“RISC”) microprocessor, a very long instruction word (“VLIW”) computing microprocessor, a processor implementing a combination of instruction sets, or any other processor device, such as a digital signal processor, for example. In at least one embodiment, processor 902 may be coupled to a processor bus 910 that may transmit data signals between processor 902 and other components in computer system 900.

In at least one embodiment, processor 902 may include, without limitation, a Level 1 (“L1”) internal cache memory (“cache”) 904. In at least one embodiment, processor 902 may have a single internal cache or multiple levels of internal cache. In at least one embodiment, cache memory may reside external to processor 902. Other embodiments may also include a combination of both internal and external caches depending on particular implementation and needs. In at least one embodiment, register file 906 may store different types of data in various registers including, without limitation, integer registers, floating point registers, status registers, and instruction pointer register.

In at least one embodiment, execution unit 908, including, without limitation, logic to perform integer and floating point operations, also resides in processor 902. In at least one embodiment, processor 902 may also include a microcode (“ucode”) read only memory (“ROM”) that stores microcode for certain macro instructions. In at least one embodiment, execution unit 908 may include logic to handle a packed instruction set 909. In at least one embodiment, by including packed instruction set 909 in an instruction set of a general-purpose processor 902, along with associated circuitry to execute instructions, operations used by many multimedia applications may be performed using packed data in a general-purpose processor 902. In one or more embodiments, many multimedia applications may be accelerated and executed more efficiently by using full width of a processor's data bus for performing operations on packed data, which may eliminate need to transfer smaller units of data across processor's data bus to perform one or more operations one data element at a time.

In at least one embodiment, execution unit 908 may also be used in microcontrollers, embedded processors, graphics devices, DSPs, and other types of logic circuits. In at least one embodiment, computer system 900 may include, without limitation, a memory 920. In at least one embodiment, memory 920 may be implemented as a Dynamic Random Access Memory (“DRAM”) device, a Static Random Access Memory (“SRAM”) device, flash memory device, or other memory device. In at least one embodiment, memory 920 may store instruction(s) 919 and/or data 921 represented by data signals that may be executed by processor 902.

In at least one embodiment, system logic chip may be coupled to processor bus 910 and memory 920. In at least one embodiment, system logic chip may include, without limitation, a memory controller hub (“MCH”) 916, and processor 902 may communicate with MCH 916 via processor bus 910. In at least one embodiment, MCH 916 may provide a high bandwidth memory path 918 to memory 920 for instruction and data storage and for storage of graphics commands, data and textures. In at least one embodiment, MCH 916 may direct data signals between processor 902, memory 920, and other components in computer system 900 and to bridge data signals between processor bus 910, memory 920, and a system I/O 922. In at least one embodiment, system logic chip may provide a graphics port for coupling to a graphics controller. In at least one embodiment, MCH 916 may be coupled to memory 920 through a high bandwidth memory path 918 and graphics/video card 912 may be coupled to MCH 916 through an Accelerated Graphics Port (“AGP”) interconnect 914.

In at least one embodiment, computer system 900 may use system I/O 922 that is a proprietary hub interface bus to couple MCH 916 to I/O controller hub (“ICH”) 930. In at least one embodiment, ICH 930 may provide direct connections to some I/O devices via a local I/O bus. In at least one embodiment, local I/O bus may include, without limitation, a high-speed I/O bus for connecting peripherals to memory 920, chipset, and processor 902. Examples may include, without limitation, an audio controller 929, a firmware hub (“flash BIOS”) 928, a wireless transceiver 926, a data storage 924, a legacy I/O controller 923 containing user input and keyboard interfaces 925, a serial expansion port 927, such as Universal Serial Bus (“USB”), and a network controller 934. Data storage 924 may comprise a hard disk drive, a floppy disk drive, a CD-ROM device, a flash memory device, or other mass storage device.

In at least one embodiment, FIG. 9 illustrates a system, which includes interconnected hardware devices or “chips”, whereas in other embodiments, FIG. 9 may illustrate an exemplary System on a Chip (“SoC”). In at least one embodiment, devices may be interconnected with proprietary interconnects, standardized interconnects (e.g., PCIe) or some combination thereof. In at least one embodiment, one or more components of computer system 900 are interconnected using compute express link (CXL) interconnects.

Inference and/or training logic 715 are used to perform inferencing and/or training operations associated with one or more embodiments. Details regarding inference and/or training logic 715 are provided below in conjunction with FIGS. 7A and/or 7B. In at least one embodiment, inference and/or training logic 715 may be used in system FIG. 9 for inferencing or predicting operations based, at least in part, on weight parameters calculated using neural network training operations, neural network functions and/or architectures, or neural network use cases described herein.

Such components can be used for packet loss mitigation.

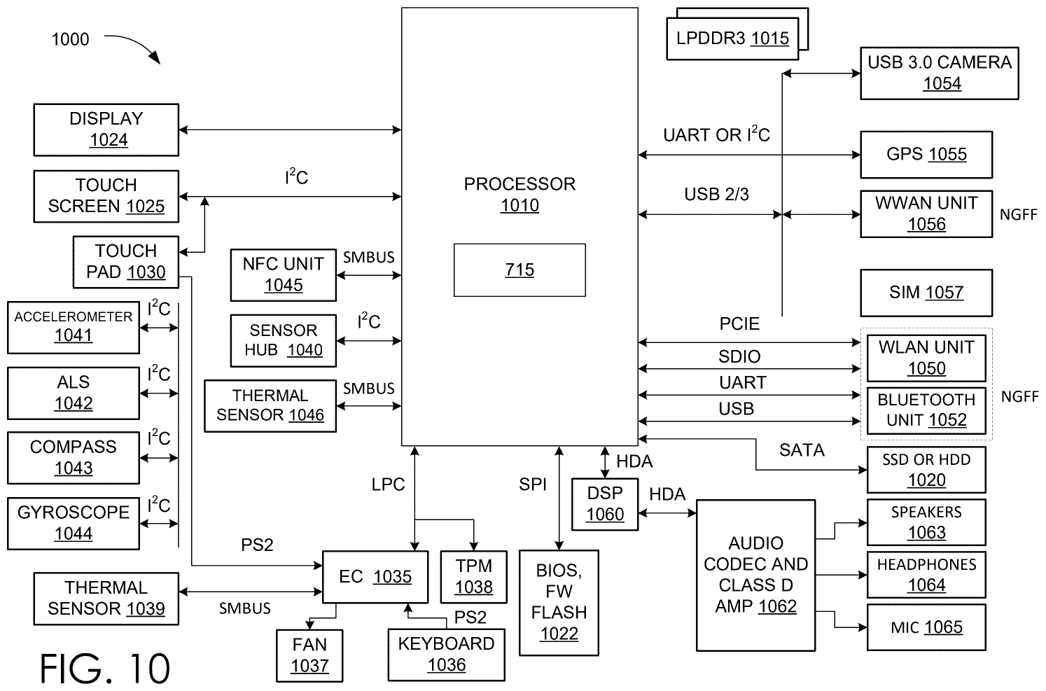

FIG. 10 is a block diagram illustrating an electronic device 1000 for utilizing a processor 1010, according to at least one embodiment. In at least one embodiment, electronic device 1000 may be, for example and without limitation, a notebook, a tower server, a rack server, a blade server, a laptop, a desktop, a tablet, a mobile device, a phone, an embedded computer, or any other suitable electronic device.

In at least one embodiment, electronic device 1000 may include, without limitation, processor 1010 communicatively coupled to any suitable number or kind of components, peripherals, modules, or devices. In at least one embodiment, processor 1010 coupled using a bus or interface, such as a 1° C. bus, a System Management Bus (“SMBus”), a Low Pin Count (LPC) bus, a Serial Peripheral Interface (“SPI”), a High Definition Audio (“HDA”) bus, a Serial Advance Technology Attachment (“SATA”) bus, a Universal Serial Bus (“USB”) (versions 1, 2, 3), or a Universal Asynchronous Receiver/Transmitter (“UART”) bus. In at least one embodiment, FIG. 10 illustrates a system, which includes interconnected hardware devices or “chips”, whereas in other embodiments, FIG. 10 may illustrate an exemplary System on a Chip (“SoC”). In at least one embodiment, devices illustrated in FIG. 10 may be interconnected with proprietary interconnects, standardized interconnects (e.g., PCIe) or some combination thereof. In at least one embodiment, one or more components of FIG. 10 are interconnected using compute express link (CXL) interconnects.

In at least one embodiment, FIG. 10 may include a display 1024, a touch screen 1025, a touch pad 1030, a Near Field Communications unit (“NFC”) 1045, a sensor hub 1040, a thermal sensor 1046, an Express Chipset (“EC”) 1035, a Trusted Platform Module (“TPM”) 1038, BIOS/firmware/flash memory (“BIOS, FW Flash”) 1022, a DSP 1060, a drive 1020 such as a Solid State Disk (“SSD”) or a Hard Disk Drive (“HDD”), a wireless local area network unit (“WLAN”) 1050, a Bluetooth unit 1052, a Wireless Wide Area Network unit (“WWAN”) 1056, a Global Positioning System (GPS) 1055, a camera (“USB 3.0 camera”) 1054 such as a USB 3.0 camera, and/or a Low Power Double Data Rate (“LPDDR”) memory unit (“LPDDR3”) 1015 implemented in, for example, LPDDR3 standard. These components may each be implemented in any suitable manner.

In at least one embodiment, other components may be communicatively coupled to processor 1010 through components discussed above. In at least one embodiment, an accelerometer 1041, Ambient Light Sensor (“ALS”) 1042, compass 1043, and a gyroscope 1044 may be communicatively coupled to sensor hub 1040. In at least one embodiment, thermal sensor 1039, a fan 1037, a keyboard 1036, and a touch pad 1030 may be communicatively coupled to EC 1035. In at least one embodiment, speakers 1063, headphones 1064, and microphone (“mic”) 1065 may be communicatively coupled to an audio unit (“audio codec and class d amp”) 1062, which may in turn be communicatively coupled to DSP 1060. In at least one embodiment, audio unit 1062 may include, for example and without limitation, an audio coder/decoder (“codec”) and a class D amplifier. In at least one embodiment, SIM card (“SIM”) 1057 may be communicatively coupled to WWAN unit 1056. In at least one embodiment, components such as WLAN unit 1050 and Bluetooth unit 1052, as well as WWAN unit 1056 may be implemented in a Next Generation Form Factor (“NGFF”).

Inference and/or training logic 715 are used to perform inferencing and/or training operations associated with one or more embodiments. Details regarding inference and/or training logic 715 are provided below in conjunction with FIGS. 7A and/or 7B. In at least one embodiment, inference and/or training logic 715 may be used in system FIG. 10 for inferencing or predicting operations based, at least in part, on weight parameters calculated using neural network training operations, neural network functions and/or architectures, or neural network use cases described herein.

Such components can be used for packet loss mitigation.

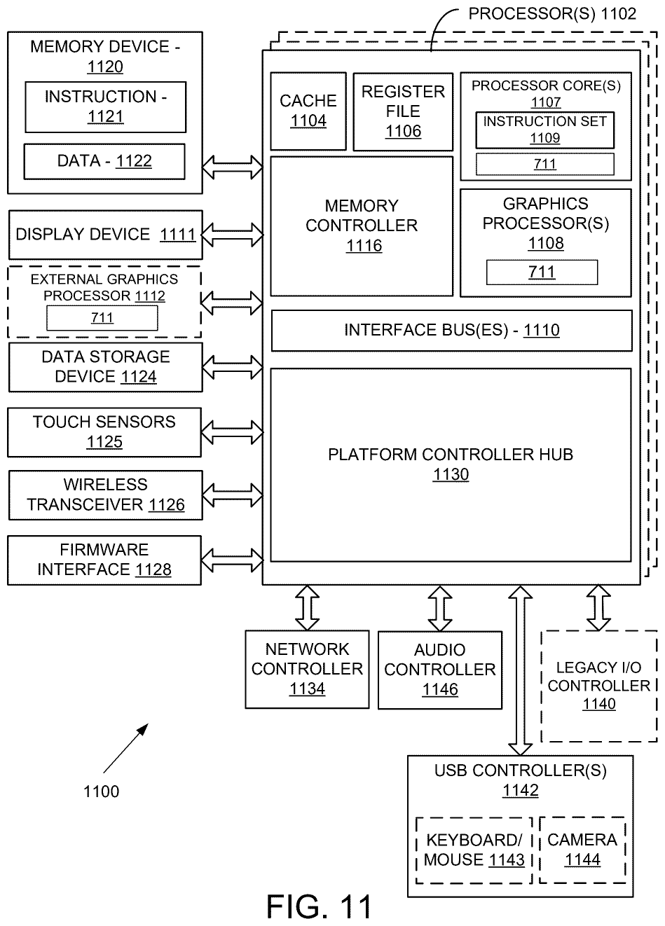

FIG. 11 is a block diagram of a processing system, according to at least one embodiment. In at least one embodiment, system 1100 includes one or more processor(s) 1102 and one or more graphics processor(s) 1108, and may be a single processor desktop system, a multiprocessor workstation system, or a server system having a large number of processor(s) 1102 or processor core(s) 1107. In at least one embodiment, system 1100 is a processing platform incorporated within a system-on-a-chip (SoC) integrated circuit for use in mobile, handheld, or embedded devices.

In at least one embodiment, system 1100 can include, or be incorporated within a server-based gaming platform, a game console, including a game and media console, a mobile gaming console, a handheld game console, or an online game console. In at least one embodiment, system 1100 is a mobile phone, smart phone, tablet computing device or mobile Internet device. In at least one embodiment, system 1100 can also include, coupled with, or be integrated within a wearable device, such as a smart watch wearable device, smart eyewear device, augmented reality device, or virtual reality device. In at least one embodiment, system 1100 is a television or set top box device having one or more processor(s) 1102 and a graphical interface generated by one or more graphics processor(s) 1108.

In at least one embodiment, one or more processor(s) 1102 each include one or more processor core(s) 1107 to process instructions which, when executed, perform operations for system and user software. In at least one embodiment, each of one or more processor core(s) 1107 is configured to process a specific instruction set 1109. In at least one embodiment, instruction set 1109 may facilitate Complex Instruction Set Computing (CISC), Reduced Instruction Set Computing (RISC), or computing via a Very Long Instruction Word (VLIW). In at least one embodiment, processor core(s) 1107 may each process a different instruction set 1109, which may include instructions to facilitate emulation of other instruction sets. In at least one embodiment, processor core(s) 1107 may also include other processing devices, such a Digital Signal Processor (DSP).

In at least one embodiment, processor(s) 1102 includes cache memory 1104. In at least one embodiment, processor(s) 1102 can have a single internal cache or multiple levels of internal cache. In at least one embodiment, cache memory is shared among various components of processor(s) 1102. In at least one embodiment, processor(s) 1102 also uses an external cache (e.g., a Level-3 (L3) cache or Last Level Cache (LLC)) (not shown), which may be shared among processor core(s) 1107 using known cache coherency techniques. In at least one embodiment, register file 1106 is additionally included in processor(s) 1102 which may include different types of registers for storing different types of data (e.g., integer registers, floating point registers, status registers, and an instruction pointer register). In at least one embodiment, register file 1106 may include general-purpose registers or other registers.

In at least one embodiment, one or more processor(s) 1102 are coupled with one or more interface bus(es) 1110 to transmit communication signals such as address, data, or control signals between processor(s) 1102 and other components in system 1100. In at least one embodiment, interface bus(es) 1110, in one embodiment, can be a processor bus, such as a version of a Direct Media Interface (DMI) bus. In at least one embodiment, interface bus(es) 1110 is not limited to a DMI bus, and may include one or more Peripheral Component Interconnect buses (e.g., PCI, PCI Express), memory busses, or other types of interface busses. In at least one embodiment processor(s) 1102 include an integrated memory controller 1116 and a platform controller hub 1130. In at least one embodiment, memory controller 1116 facilitates communication between a memory device and other components of system 1100, while platform controller hub (PCH) 1130 provides connections to I/O devices via a local I/O bus.

In at least one embodiment, memory device 1120 can be a dynamic random access memory (DRAM) device, a static random access memory (SRAM) device, flash memory device, phase-change memory device, or some other memory device having suitable performance to serve as process memory. In at least one embodiment memory device 1120 can operate as system memory for system 1100, to store data 1122 and instruction 1121 for use when one or more processor(s) 1102 executes an application or process. In at least one embodiment, memory controller 1116 also couples with an optional external graphics processor 1112, which may communicate with one or more graphics processor(s) 1108 in processor(s) 1102 to perform graphics and media operations. In at least one embodiment, a display device 1111 can connect to processor(s) 1102. In at least one embodiment display device 1111 can include one or more of an internal display device, as in a mobile electronic device or a laptop device or an external display device attached via a display interface (e.g., DisplayPort, etc.). In at least one embodiment, display device 1111 can include a head mounted display (HMD) such as a stereoscopic display device for use in virtual reality (VR) applications or augmented reality (AR) applications.

In at least one embodiment, platform controller hub 1130 enables peripherals to connect to memory device 1120 and processor(s) 1102 via a high-speed I/O bus. In at least one embodiment, I/O peripherals include, but are not limited to, an audio controller 1146, a network controller 1134, a firmware interface 1128, a wireless transceiver 1126, touch sensors 1125, a data storage device 1124 (e.g., hard disk drive, flash memory, etc.). In at least one embodiment, data storage device 1124 can connect via a storage interface (e.g., SATA) or via a peripheral bus, such as a Peripheral Component Interconnect bus (e.g., PCI, PCI Express). In at least one embodiment, touch sensors 1125 can include touch screen sensors, pressure sensors, or fingerprint sensors. In at least one embodiment, wireless transceiver 1126 can be a Wi-Fi transceiver, a Bluetooth transceiver, or a mobile network transceiver such as a 3G, 4G, or Long Term Evolution (LTE) transceiver. In at least one embodiment, firmware interface 1128 enables communication with system firmware, and can be, for example, a unified extensible firmware interface (UEFI). In at least one embodiment, network controller 1134 can enable a network connection to a wired network. In at least one embodiment, a high-performance network controller (not shown) couples with interface bus(es) 1110. In at least one embodiment, audio controller 1146 is a multi-channel high definition audio controller. In at least one embodiment, system 1100 includes an optional legacy I/O controller 1140 for coupling legacy (e.g., Personal System 2 (PS/2)) devices to system. In at least one embodiment, platform controller hub 1130 can also connect to one or more Universal Serial Bus (USB) controller(s) 1142 connect input devices, such as keyboard and mouse 1143 combinations, a camera 1144, or other USB input devices.

In at least one embodiment, an instance of memory controller 1116 and platform controller hub 1130 may be integrated into a discreet external graphics processor, such as external graphics processor 1112. In at least one embodiment, platform controller hub 1130 and/or memory controller 1116 may be external to one or more processor(s) 1102. For example, in at least one embodiment, system 1100 can include an external memory controller 1116 and platform controller hub 1130, which may be configured as a memory controller hub and peripheral controller hub within a system chipset that is in communication with processor(s) 1102.

Inference and/or training logic 715 are used to perform inferencing and/or training operations associated with one or more embodiments. Details regarding inference and/or training logic 715 are provided below in conjunction with FIGS. 7A and/or 7B. In at least one embodiment portions or all of inference and/or training logic 715 may be incorporated into graphics processor 1500. For example, in at least one embodiment, training and/or inferencing techniques described herein may use one or more of ALUs embodied in a graphics processor. Moreover, in at least one embodiment, inferencing and/or training operations described herein may be done using logic other than logic illustrated in FIGS. 7A and/or 7B. In at least one embodiment, weight parameters may be stored in on-chip or off-chip memory and/or registers (shown or not shown) that configure ALUs of a graphics processor to perform one or more machine learning algorithms, neural network architectures, use cases, or training techniques described herein.

Such components can be used for packet loss mitigation.

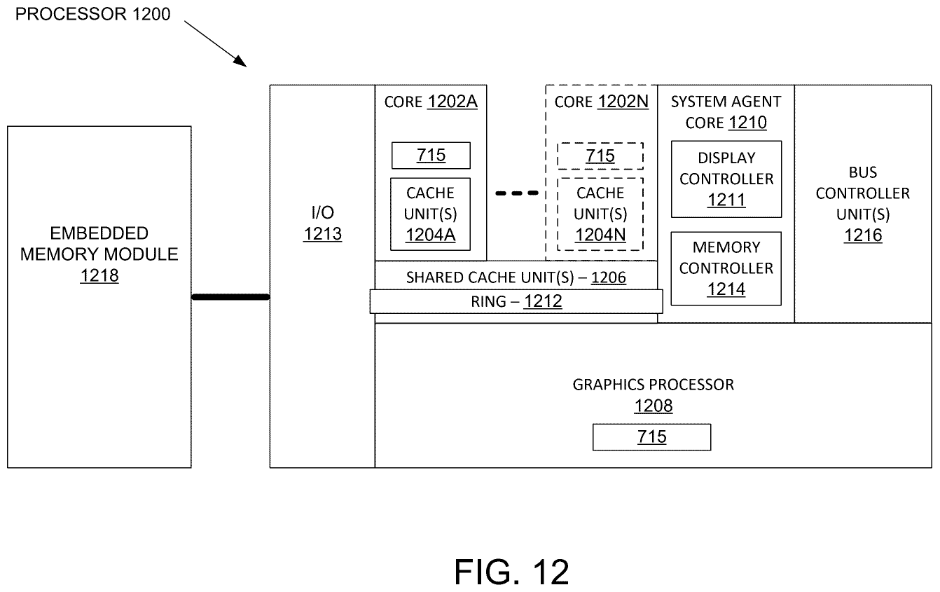

FIG. 12 is a block diagram of a processor 1200 having one or more processor core(s) 1202A-1202N, an integrated memory controller 1214, and an integrated graphics processor 1208, according to at least one embodiment. In at least one embodiment, processor 1200 can include additional cores up to and including additional core 1202N represented by dashed lined boxes. In at least one embodiment, each of processor core(s) 1202A-1202N includes one or more internal cache unit(s) 1204A-1204N. In at least one embodiment, each processor core also has access to one or more shared cached unit(s) 1206.

In at least one embodiment, internal cache unit(s) 1204A-1204N and shared cache unit(s) 1206 represent a cache memory hierarchy within processor 1200. In at least one embodiment, cache unit(s) 1204A-1204N may include at least one level of instruction and data cache within each processor core and one or more levels of shared mid-level cache, such as a Level 2 (L2), Level 3 (L3), Level 4 (L4), or other levels of cache, where a highest level of cache before external memory is classified as an LLC. In at least one embodiment, cache coherency logic maintains coherency between various cache unit(s) 1206 and 1204A-1204N.

In at least one embodiment, processor 1200 may also include a set of one or more bus controller unit(s) 1216 and a system agent core 1210. In at least one embodiment, one or more bus controller unit(s) 1216 manage a set of peripheral buses, such as one or more PCI or PCI express busses. In at least one embodiment, system agent core 1210 provides management functionality for various processor components. In at least one embodiment, system agent core 1210 includes one or more integrated memory controllers 1214 to manage access to various external memory devices (not shown).

In at least one embodiment, one or more of processor core(s) 1202A-1202N include support for simultaneous multi-threading. In at least one embodiment, system agent core 1210 includes components for coordinating and processor core(s) 1202A-1202N during multi-threaded processing. In at least one embodiment, system agent core 1210 may additionally include a power control unit (PCU), which includes logic and components to regulate one or more power states of processor core(s) 1202A-1202N and graphics processor 1208.

In at least one embodiment, processor 1200 additionally includes graphics processor 1208 to execute graphics processing operations. In at least one embodiment, graphics processor 1208 couples with shared cache unit(s) 1206, and system agent core 1210, including one or more integrated memory controllers 1214. In at least one embodiment, system agent core 1210 also includes a display controller 1211 to drive graphics processor output to one or more coupled displays. In at least one embodiment, display controller 1211 may also be a separate module coupled with graphics processor 1208 via at least one interconnect, or may be integrated within graphics processor 1208.

In at least one embodiment, a ring based interconnect unit 1212 is used to couple internal components of processor 1200. In at least one embodiment, an alternative interconnect unit may be used, such as a point-to-point interconnect, a switched interconnect, or other techniques. In at least one embodiment, graphics processor 1208 couples with a ring based interconnect unit 1212 via an I/O link 1213.

In at least one embodiment, I/O link 1213 represents at least one of multiple varieties of I/O interconnects, including an on package I/O interconnect which facilitates communication between various processor components and a high-performance embedded memory module 1218, such as an eDRAM module. In at least one embodiment, each of processor core(s) 1202A-1202N and graphics processor 1208 use embedded memory modules 1218 as a shared Last Level Cache.

In at least one embodiment, processor core(s) 1202A-1202N are homogenous cores executing a common instruction set architecture. In at least one embodiment, processor core(s) 1202A-1202N are heterogeneous in terms of instruction set architecture (ISA), where one or more of processor core(s) 1202A-1202N execute a common instruction set, while one or more other cores of processor core(s) 1202A-1202N executes a subset of a common instruction set or a different instruction set. In at least one embodiment, processor core(s) 1202A-1202N are heterogeneous in terms of microarchitecture, where one or more cores having a relatively higher power consumption couple with one or more power cores having a lower power consumption. In at least one embodiment, processor 1200 can be implemented on one or more chips or as an SoC integrated circuit.

Inference and/or training logic 715 are used to perform inferencing and/or training operations associated with one or more embodiments. Details regarding inference and/or training logic 715 are provided below in conjunction with FIGS. 7A and/or 7B. In at least one embodiment portions or all of inference and/or training logic 715 may be incorporated into processor 1200. For example, in at least one embodiment, training and/or inferencing techniques described herein may use one or more of ALUs embodied in graphics processor 1208, graphics core(s) 1202A-1202N, or other components in FIG. 12. Moreover, in at least one embodiment, inferencing and/or training operations described herein may be done using logic other than logic illustrated in FIGS. 7A and/or 7B. In at least one embodiment, weight parameters may be stored in on-chip or off-chip memory and/or registers (shown or not shown) that configure ALUs of graphics processor 1200 to perform one or more machine learning algorithms, neural network architectures, use cases, or training techniques described herein.

Such components can be used for packet loss mitigation.

### Virtualized Computing Platform

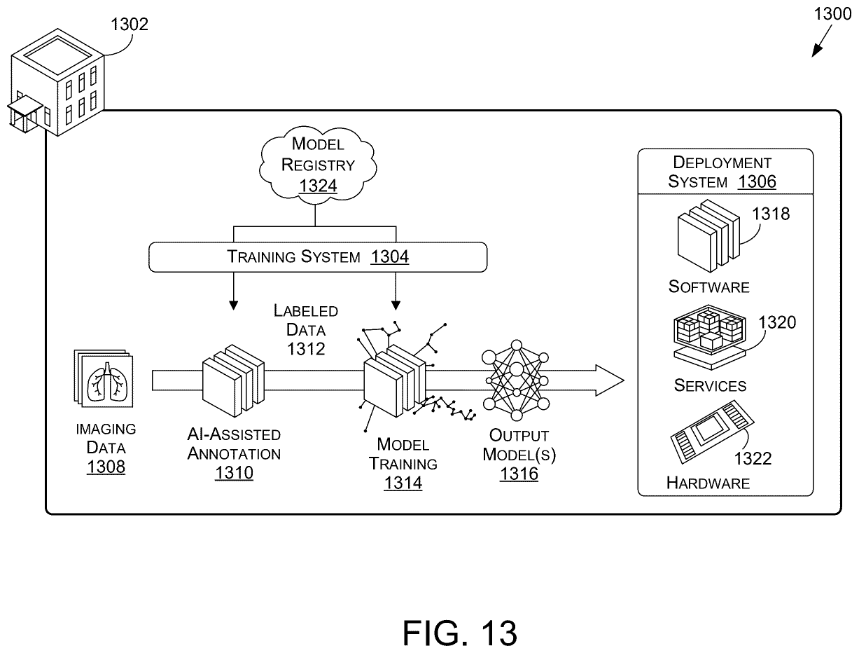

FIG. 13 is an example data flow diagram for a process 1300 of generating and deploying an image processing and inferencing pipeline, in accordance with at least one embodiment. In at least one embodiment, process 1300 may be deployed for use with imaging devices, processing devices, and/or other device types at one or more facilities 1302. Process 1300 may be executed within a training system 1304 and/or a deployment system 1306. In at least one embodiment, training system 1304 may be used to perform training, deployment, and implementation of machine learning models (e.g., neural networks, object detection algorithms, computer vision algorithms, etc.) for use in deployment system 1306. In at least one embodiment, deployment system 1306 may be configured to offload processing and compute resources among a distributed computing environment to reduce infrastructure requirements at facility 1302. In at least one embodiment, one or more applications in a pipeline may use or call upon services (e.g., inference, visualization, compute, AI, etc.) of deployment system 1306 during execution of applications.

In at least one embodiment, some of applications used in advanced processing and inferencing pipelines may use machine learning models or other AI to perform one or more processing steps. In at least one embodiment, machine learning models may be trained at facility 1302 using data 1308 (such as imaging data) generated at facility 1302 (and stored on one or more picture archiving and communication system (PACS) servers at facility 1302), may be trained using imaging or sequencing data 1308 from another facility(ies), or a combination thereof. In at least one embodiment, training system 1304 may be used to provide applications, services, and/or other resources for generating working, deployable machine learning models for deployment system 1306.

In at least one embodiment, model registry 1324 may be backed by object storage that may support versioning and object metadata. In at least one embodiment, object storage may be accessible through, for example, a cloud storage compatible application programming interface (API) from within a cloud platform. In at least one embodiment, machine learning models within model registry 1324 may uploaded, listed, modified, or deleted by developers or partners of a system interacting with an API. In at least one embodiment, an API may provide access to methods that allow users with appropriate credentials to associate models with applications, such that models may be executed as part of execution of containerized instantiations of applications.

In at least one embodiment, training system 1304 (FIG. 13) may include a scenario where facility 1302 is training their own machine learning model, or has an existing machine learning model that needs to be optimized or updated. In at least one embodiment, imaging data 1308 generated by imaging device(s), sequencing devices, and/or other device types may be received. In at least one embodiment, once imaging data 1308 is received, AI-assisted annotation 1310 may be used to aid in generating annotations corresponding to imaging data 1308 to be used as ground truth data for a machine learning model. In at least one embodiment, AI-assisted annotation 1310 may include one or more machine learning models (e.g., convolutional neural networks (CNNs)) that may be trained to generate annotations corresponding to certain types of imaging data 1308 (e.g., from certain devices). In at least one embodiment, AI-assisted annotation 1310 may then be used directly, or may be adjusted or fine-tuned using an annotation tool to generate ground truth data. In at least one embodiment, AI-assisted annotation 1310, labeled data 1312, or a combination thereof may be used as ground truth data for training a machine learning model. In at least one embodiment, a trained machine learning model may be referred to as output model(s) 1316, and may be used by deployment system 1306, as described herein.

In at least one embodiment, a training pipeline may include a scenario where facility 1302 needs a machine learning model for use in performing one or more processing tasks for one or more applications in deployment system 1306, but facility 1302 may not currently have such a machine learning model (or may not have a model that is optimized, efficient, or effective for such purposes). In at least one embodiment, an existing machine learning model may be selected from a model registry 1324. In at least one embodiment, model registry 1324 may include machine learning models trained to perform a variety of different inference tasks on imaging data. In at least one embodiment, machine learning models in model registry 1324 may have been trained on imaging data from different facilities than facility 1302 (e.g., facilities remotely located). In at least one embodiment, machine learning models may have been trained on imaging data from one location, two locations, or any number of locations. In at least one embodiment, when being trained on imaging data from a specific location, training may take place at that location, or at least in a manner that protects confidentiality of imaging data or restricts imaging data from being transferred off-premises. In at least one embodiment, once a model is trained—or partially trained—at one location, a machine learning model may be added to model registry 1324. In at least one embodiment, a machine learning model may then be retrained, or updated, at any number of other facilities, and a retrained or updated model may be made available in model registry 1324. In at least one embodiment, a machine learning model may then be selected from model registry 1324—and referred to as output model(s) 1316—and may be used in deployment system 1306 to perform one or more processing tasks for one or more applications of a deployment system.

In at least one embodiment, a scenario may include facility 1302 requiring a machine learning model for use in performing one or more processing tasks for one or more applications in deployment system 1306, but facility 1302 may not currently have such a machine learning model (or may not have a model that is optimized, efficient, or effective for such purposes). In at least one embodiment, a machine learning model selected from model registry 1324 may not be fine-tuned or optimized for imaging data 1308 generated at facility 1302 because of differences in populations, robustness of training data used to train a machine learning model, diversity in anomalies of training data, and/or other issues with training data. In at least one embodiment, AI-assisted annotation 1310 may be used to aid in generating annotations corresponding to imaging data 1308 to be used as ground truth data for retraining or updating a machine learning model. In at least one embodiment, labeled data 1312 may be used as ground truth data for training a machine learning model. In at least one embodiment, retraining or updating a machine learning model may be referred to as model training 1314. In at least one embodiment, model training 1314—e.g., AI-assisted annotation 1310, labeled data 1312, or a combination thereof—may be used as ground truth data for retraining or updating a machine learning model. In at least one embodiment, a trained machine learning model may be referred to as output model(s) 1316, and may be used by deployment system 1306, as described herein.

In at least one embodiment, deployment system 1306 may include software 1318, services 1320, hardware 1322, and/or other components, features, and functionality. In at least one embodiment, deployment system 1306 may include a software “stack,” such that software 1318 may be built on top of services 1320 and may use services 1320 to perform some or all of processing tasks, and services 1320 and software 1318 may be built on top of hardware 1322 and use hardware 1322 to execute processing, storage, and/or other compute tasks of deployment system 1306. In at least one embodiment, software 1318 may include any number of different containers, where each container may execute an instantiation of an application. In at least one embodiment, each application may perform one or more processing tasks in an advanced processing and inferencing pipeline (e.g., inferencing, object detection, feature detection, segmentation, image enhancement, calibration, etc.). In at least one embodiment, an advanced processing and inferencing pipeline may be defined based on selections of different containers that are desired or required for processing imaging data 1308, in addition to containers that receive and configure imaging data for use by each container and/or for use by facility 1302 after processing through a pipeline (e.g., to convert outputs back to a usable data type). In at least one embodiment, a combination of containers within software 1318 (e.g., that make up a pipeline) may be referred to as a virtual instrument (as described in more detail herein), and a virtual instrument may leverage services 1320 and hardware 1322 to execute some or all processing tasks of applications instantiated in containers.

In at least one embodiment, a data processing pipeline may receive input data (e.g., imaging data 1308) in a specific format in response to an inference request (e.g., a request from a user of deployment system 1306). In at least one embodiment, input data may be representative of one or more images, video, and/or other data representations generated by one or more imaging devices. In at least one embodiment, data may undergo pre-processing as part of data processing pipeline to prepare data for processing by one or more applications. In at least one embodiment, post-processing may be performed on an output of one or more inferencing tasks or other processing tasks of a pipeline to prepare an output data for a next application and/or to prepare output data for transmission and/or use by a user (e.g., as a response to an inference request). In at least one embodiment, inferencing tasks may be performed by one or more machine learning models, such as trained or deployed neural networks, which may include output model(s) 1316 of training system 1304.

In at least one embodiment, tasks of data processing pipeline may be encapsulated in a container(s) that each represents a discrete, fully functional instantiation of an application and virtualized computing environment that is able to reference machine learning models. In at least one embodiment, containers or applications may be published into a private (e.g., limited access) area of a container registry (described in more detail herein), and trained or deployed models may be stored in model registry 1324 and associated with one or more applications. In at least one embodiment, images of applications (e.g., container images) may be available in a container registry, and once selected by a user from a container registry for deployment in a pipeline, an image may be used to generate a container for an instantiation of an application for use by a user's system.

In at least one embodiment, developers (e.g., software developers, clinicians, doctors, etc.) may develop, publish, and store applications (e.g., as containers) for performing image processing and/or inferencing on supplied data. In at least one embodiment, development, publishing, and/or storing may be performed using a software development kit (SDK) associated with a system (e.g., to ensure that an application and/or container developed is compliant with or compatible with a system). In at least one embodiment, an application that is developed may be tested locally (e.g., at a first facility, on data from a first facility) with an SDK which may support at least some of services 1320 as a system (e.g., processor 1200 of FIG. 12). In at least one embodiment, because DICOM objects may contain anywhere from one to hundreds of images or other data types, and due to a variation in data, a developer may be responsible for managing (e.g., setting constructs for, building pre-processing into an application, etc.) extraction and preparation of incoming data. In at least one embodiment, once validated by process 1300 (e.g., for accuracy), an application may be available in a container registry for selection and/or implementation by a user to perform one or more processing tasks with respect to data at a facility (e.g., a second facility) of a user.

In at least one embodiment, developers may then share applications or containers through a network for access and use by users of a system (e.g., process 1300 of FIG. 13). In at least one embodiment, completed and validated applications or containers may be stored in a container registry and associated machine learning models may be stored in model registry 1324. In at least one embodiment, a requesting entity—who provides an inference or image processing request—may browse a container registry and/or model registry 1324 for an application, container, dataset, machine learning model, etc., select a desired combination of elements for inclusion in data processing pipeline, and submit an imaging processing request. In at least one embodiment, a request may include input data (and associated patient data, in some examples) that is necessary to perform a request, and/or may include a selection of application(s) and/or machine learning models to be executed in processing a request. In at least one embodiment, a request may then be passed to one or more components of deployment system 1306 (e.g., a cloud) to perform processing of data processing pipeline. In at least one embodiment, processing by deployment system 1306 may include referencing selected elements (e.g., applications, containers, models, etc.) from a container registry and/or model registry 1324. In at least one embodiment, once results are generated by a pipeline, results may be returned to a user for reference (e.g., for viewing in a viewing application suite executing on a local, on-premises workstation or terminal).

In at least one embodiment, to aid in processing or execution of applications or containers in pipelines, services 1320 may be leveraged. In at least one embodiment, services 1320 may include compute services, artificial intelligence (AI) services, visualization services, and/or other service types. In at least one embodiment, services 1320 may provide functionality that is common to one or more applications in software 1318, so functionality may be abstracted to a service that may be called upon or leveraged by applications. In at least one embodiment, functionality provided by services 1320 may run dynamically and more efficiently, while also scaling well by allowing applications to process data in parallel (e.g., using a parallel computing platform 1230 (FIG. 12)). In at least one embodiment, rather than each application that shares a same functionality offered by services 1320 being required to have a respective instance of services 1320, services 1320 may be shared between and among various applications. In at least one embodiment, services may include an inference server or engine that may be used for executing detection or segmentation tasks, as non-limiting examples. In at least one embodiment, a model training service may be included that may provide machine learning model training and/or retraining capabilities. In at least one embodiment, a data augmentation service may further be included that may provide GPU accelerated data (e.g., DICOM, RIS, CIS, REST compliant, RPC, raw, etc.) extraction, resizing, scaling, and/or other augmentation. In at least one embodiment, a visualization service may be used that may add image rendering effects—such as ray-tracing, rasterization, denoising, sharpening, etc.—to add realism to two-dimensional (2D) and/or three-dimensional (3D) models. In at least one embodiment, virtual instrument services may be included that provide for beam-forming, segmentation, inferencing, imaging, and/or support for other applications within pipelines of virtual instruments.

In at least one embodiment, where services 1320 includes an AI service (e.g., an inference service), one or more machine learning models may be executed by calling upon (e.g., as an API call) an inference service (e.g., an inference server) to execute machine learning model(s), or processing thereof, as part of application execution. In at least one embodiment, where another application includes one or more machine learning models for segmentation tasks, an application may call upon an inference service to execute machine learning models for performing one or more of processing operations associated with segmentation tasks. In at least one embodiment, software 1318 implementing advanced processing and inferencing pipeline that includes segmentation application and anomaly detection application may be streamlined because each application may call upon a same inference service to perform one or more inferencing tasks.

In at least one embodiment, hardware 1322 may include GPUs, CPUs, graphics cards, an AI/deep learning system (e.g., an AI supercomputer, such as NVIDIA's DGX), a cloud platform, or a combination thereof. In at least one embodiment, different types of hardware 1322 may be used to provide efficient, purpose-built support for software 1318 and services 1320 in deployment system 1306. In at least one embodiment, use of GPU processing may be implemented for processing locally (e.g., at facility 1302), within an AI/deep learning system, in a cloud system, and/or in other processing components of deployment system 1306 to improve efficiency, accuracy, and efficacy of image processing and generation. In at least one embodiment, software 1318 and/or services 1320 may be optimized for GPU processing with respect to deep learning, machine learning, and/or high-performance computing, as non-limiting examples. In at least one embodiment, at least some of computing environment of deployment system 1306 and/or training system 1304 may be executed in a datacenter one or more supercomputers or high performance computing systems, with GPU optimized software (e.g., hardware and software combination of NVIDIA's DGX System). In at least one embodiment, hardware 1322 may include any number of GPUs that may be called upon to perform processing of data in parallel, as described herein. In at least one embodiment, cloud platform may further include GPU processing for GPU-optimized execution of deep learning tasks, machine learning tasks, or other computing tasks. In at least one embodiment, cloud platform (e.g., NVIDIA's NGC) may be executed using an AI/deep learning supercomputer(s) and/or GPU-optimized software (e.g., as provided on NVIDIA's DGX Systems) as a hardware abstraction and scaling platform. In at least one embodiment, cloud platform may integrate an application container clustering system or orchestration system (e.g., KUBERNETES) on multiple GPUs to enable seamless scaling and load balancing.

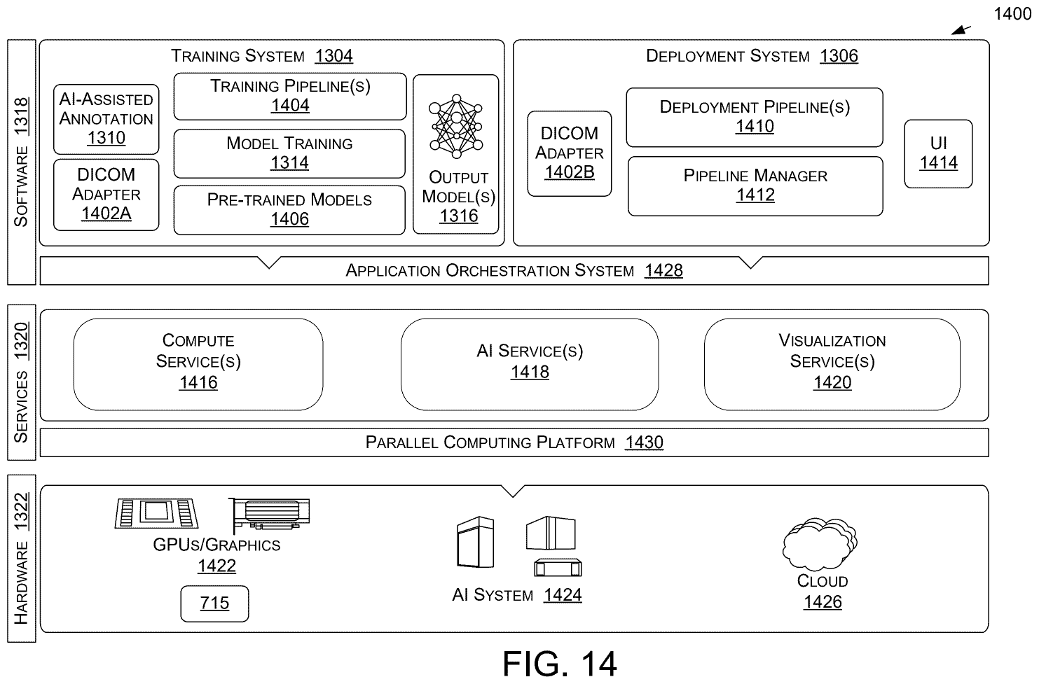

FIG. 14 is a system diagram for an example system 1400 for generating and deploying an imaging deployment pipeline, in accordance with at least one embodiment. In at least one embodiment, system 1400 may be used to implement process 1300 of FIG. 13 and/or other processes including advanced processing and inferencing pipelines. In at least one embodiment, system 1400 may include training system 1304 and deployment system 1306. In at least one embodiment, training system 1304 and deployment system 1306 may be implemented using software 1318, services 1320, and/or hardware 1322, as described herein.

In at least one embodiment, system 1400 (e.g., training system 1304 and/or deployment system 1306) may implemented in a cloud computing environment (e.g., using cloud 1426). In at least one embodiment, system 1400 may be implemented locally with respect to a healthcare services facility, or as a combination of both cloud and local computing resources. In at least one embodiment, access to APIs in cloud 1426 may be restricted to authorized users through enacted security measures or protocols. In at least one embodiment, a security protocol may include web tokens that may be signed by an authentication (e.g., AuthN, AuthZ, Gluecon, etc.) service and may carry appropriate authorization. In at least one embodiment, APIs of virtual instruments (described herein), or other instantiations of system 1400, may be restricted to a set of public IPs that have been vetted or authorized for interaction.

In at least one embodiment, various components of system 1400 may communicate between and among one another using any of a variety of different network types, including but not limited to local area networks (LANs) and/or wide area networks (WANs) via wired and/or wireless communication protocols. In at least one embodiment, communication between facilities and components of system 1400 (e.g., for transmitting inference requests, for receiving results of inference requests, etc.) may be communicated over data bus(ses), wireless data protocols (Wi-Fi), wired data protocols (e.g., Ethernet), etc.

In at least one embodiment, training system 1304 may execute training pipelines 1404, similar to those described herein with respect to FIG. 13. In at least one embodiment, where one or more machine learning models are to be used in deployment pipeline(s) 1410 by deployment system 1306, training pipelines 1404 may be used to train or retrain one or more (e.g. pre-trained) models, and/or implement one or more of pre-trained models 1406 (e.g., without a need for retraining or updating). In at least one embodiment, as a result of training pipelines 1404, output model(s) 1316 may be generated. In at least one embodiment, training pipelines 1404 may include any number of processing steps, such as but not limited to imaging data (or other input data) conversion or adaption In at least one embodiment, for different machine learning models used by deployment system 1306, different training pipelines 1404 may be used. In at least one embodiment, training pipeline 1404 similar to a first example described with respect to FIG. 13 may be used for a first machine learning model, training pipeline 1404 similar to a second example described with respect to FIG. 13 may be used for a second machine learning model, and training pipeline 1404 similar to a third example described with respect to FIG. 13 may be used for a third machine learning model. In at least one embodiment, any combination of tasks within training system 1304 may be used depending on what is required for each respective machine learning model. In at least one embodiment, one or more of machine learning models may already be trained and ready for deployment so machine learning models may not undergo any processing by training system 1304, and may be implemented by deployment system 1306.

In at least one embodiment, output model(s) 1316 and/or pre-trained models 1406 may include any types of machine learning models depending on implementation or embodiment. In at least one embodiment, and without limitation, machine learning models used by system 1400 may include machine learning model(s) using linear regression, logistic regression, decision trees, support vector machines (SVM), Naïve Bayes, k-nearest neighbor (Knn), K means clustering, random forest, dimensionality reduction algorithms, gradient boosting algorithms, neural networks (e.g., auto-encoders, convolutional, recurrent, perceptrons, Long/Short Term Memory (LSTM), Hopfield, Boltzmann, deep belief, deconvolutional, generative adversarial, liquid state machine, etc.), and/or other types of machine learning models.

In at least one embodiment, training pipelines 1404 may include AI-assisted annotation, as described in more detail herein with respect to at least FIG. 14B. In at least one embodiment, labeled data 1312 (e.g., traditional annotation) may be generated by any number of techniques. In at least one embodiment, labels or other annotations may be generated within a drawing program (e.g., an annotation program), a computer aided design (CAD) program, a labeling program, another type of program suitable for generating annotations or labels for ground truth, and/or may be hand drawn, in some examples. In at least one embodiment, ground truth data may be synthetically produced (e.g., generated from computer models or renderings), real produced (e.g., designed and produced from real-world data), machine-automated (e.g., using feature analysis and learning to extract features from data and then generate labels), human annotated (e.g., labeler, or annotation expert, defines location of labels), and/or a combination thereof. In at least one embodiment, for each instance of imaging data 1308 (or other data type used by machine learning models), there may be corresponding ground truth data generated by training system 1304. In at least one embodiment, AI-assisted annotation may be performed as part of deployment pipeline(s) 1410; either in addition to, or in lieu of AI-assisted annotation included in training pipelines 1404. In at least one embodiment, system 1400 may include a multi-layer platform that may include a software layer (e.g., software 1318) of diagnostic applications (or other application types) that may perform one or more medical imaging and diagnostic functions. In at least one embodiment, system 1400 may be communicatively coupled to (e.g., via encrypted links) PACS server networks of one or more facilities. In at least one embodiment, system 1400 may be configured to access and referenced data from PACS servers to perform operations, such as training machine learning models, deploying machine learning models, image processing, inferencing, and/or other operations.

In at least one embodiment, a software layer may be implemented as a secure, encrypted, and/or authenticated API through which applications or containers may be invoked (e.g., called) from an external environment(s) (e.g., facility 1302). In at least one embodiment, applications may then call or execute one or more services 1320 for performing compute, AI, or visualization tasks associated with respective applications, and software 1318 and/or services 1320 may leverage hardware 1322 to perform processing tasks in an effective and efficient manner. In at least one embodiment, communications sent to, or received by, a training system 1304 and a deployment system 1306 may occur using a pair of DICOM adapters 1402A, 1402B.

In at least one embodiment, deployment system 1306 may execute deployment pipeline(s) 1410. In at least one embodiment, deployment pipeline(s) 1410 may include any number of applications that may be sequentially, non-sequentially, or otherwise applied to imaging data (and/or other data types) generated by imaging devices, sequencing devices, genomics devices, etc.—including AI-assisted annotation, as described above. In at least one embodiment, as described herein, a deployment pipeline(s) 1410 for an individual device may be referred to as a virtual instrument for a device (e.g., a virtual ultrasound instrument, a virtual CT scan instrument, a virtual sequencing instrument, etc.). In at least one embodiment, for a single device, there may be more than one deployment pipeline(s) 1410 depending on information desired from data generated by a device. In at least one embodiment, where detections of anomalies are desired from an MRI machine, there may be a first deployment pipeline(s) 1410, and where image enhancement is desired from output of an MRI machine, there may be a second deployment pipeline(s) 1410.

In at least one embodiment, an image generation application may include a processing task that includes use of a machine learning model. In at least one embodiment, a user may desire to use their own machine learning model, or to select a machine learning model from model registry 1324. In at least one embodiment, a user may implement their own machine learning model or select a machine learning model for inclusion in an application for performing a processing task. In at least one embodiment, applications may be selectable and customizable, and by defining constructs of applications, deployment and implementation of applications for a particular user are presented as a more seamless user experience. In at least one embodiment, by leveraging other features of system 1400—such as services 1320 and hardware 1322—deployment pipeline(s) 1410 may be even more user friendly, provide for easier integration, and produce more accurate, efficient, and timely results.

In at least one embodiment, deployment system 1306 may include a user interface (“UI”) 1414 (e.g., a graphical user interface, a web interface, etc.) that may be used to select applications for inclusion in deployment pipeline(s) 1410, arrange applications, modify or change applications or parameters or constructs thereof, use and interact with deployment pipeline(s) 1410 during set-up and/or deployment, and/or to otherwise interact with deployment system 1306. In at least one embodiment, although not illustrated with respect to training system 1304, UI 1414 (or a different user interface) may be used for selecting models for use in deployment system 1306, for selecting models for training, or retraining, in training system 1304, and/or for otherwise interacting with training system 1304.

In at least one embodiment, pipeline manager 1412 may be used, in addition to an application orchestration system 1428, to manage interaction between applications or containers of deployment pipeline(s) 1410 and services 1320 and/or hardware 1322. In at least one embodiment, pipeline manager 1412 may be configured to facilitate interactions from application to application, from application to services 1320, and/or from application or service to hardware 1322. In at least one embodiment, although illustrated as included in software 1318, this is not intended to be limiting, and in some examples pipeline manager 1412 may be included in services 1320. In at least one embodiment, application orchestration system 1428 (e.g., Kubernetes, DOCKER, etc.) may include a container orchestration system that may group applications into containers as logical units for coordination, management, scaling, and deployment. In at least one embodiment, by associating applications from deployment pipeline(s) 1410 (e.g., a reconstruction application, a segmentation application, etc.) with individual containers, each application may execute in a self-contained environment (e.g., at a kernel level) to increase speed and efficiency.

In at least one embodiment, each application and/or container (or image thereof) may be individually developed, modified, and deployed (e.g., a first user or developer may develop, modify, and deploy a first application and a second user or developer may develop, modify, and deploy a second application separate from a first user or developer), which may allow for focus on, and attention to, a task of a single application and/or container(s) without being hindered by tasks of another application(s) or container(s). In at least one embodiment, communication, and cooperation between different containers or applications may be aided by pipeline manager 1412 and application orchestration system 1428. In at least one embodiment, so long as an expected input and/or output of each container or application is known by a system (e.g., based on constructs of applications or containers), application orchestration system 1428 and/or pipeline manager 1412 may facilitate communication among and between, and sharing of resources among and between, each of applications or containers. In at least one embodiment, because one or more of applications or containers in deployment pipeline(s) 1410 may share same services and resources, application orchestration system 1428 may orchestrate, load balance, and determine sharing of services or resources between and among various applications or containers. In at least one embodiment, a scheduler may be used to track resource requirements of applications or containers, current usage or planned usage of these resources, and resource availability. In at least one embodiment, a scheduler may thus allocate resources to different applications and distribute resources between and among applications in view of requirements and availability of a system. In some examples, a scheduler (and/or other component of application orchestration system 1428) may determine resource availability and distribution based on constraints imposed on a system (e.g., user constraints), such as quality of service (QoS), urgency of need for data outputs (e.g., to determine whether to execute real-time processing or delayed processing), etc.

In at least one embodiment, services 1320 leveraged by and shared by applications or containers in deployment system 1306 may include compute service(s) 1416, AI service(s) 1418, visualization service(s) 1420, and/or other service types. In at least one embodiment, applications may call (e.g., execute) one or more of services 1320 to perform processing operations for an application. In at least one embodiment, compute service(s) 1416 may be leveraged by applications to perform super-computing or other high-performance computing (HPC) tasks. In at least one embodiment, compute service(s) 1416 may be leveraged to perform parallel processing (e.g., using a parallel computing platform 1430) for processing data through one or more of applications and/or one or more tasks of a single application, substantially simultaneously. In at least one embodiment, parallel computing platform 1430 (e.g., NVIDIA's CUDA) may enable general purpose computing on GPUs (GPGPU) (e.g., GPUs/Graphics 1422). In at least one embodiment, a software layer of parallel computing platform 1430 may provide access to virtual instruction sets and parallel computational elements of GPUs, for execution of compute kernels. In at least one embodiment, parallel computing platform 1430 may include memory and, in some embodiments, a memory may be shared between and among multiple containers, and/or between and among different processing tasks within a single container. In at least one embodiment, inter-process communication (IPC) calls may be generated for multiple containers and/or for multiple processes within a container to use same data from a shared segment of memory of parallel computing platform 1430 (e.g., where multiple different stages of an application or multiple applications are processing same information). In at least one embodiment, rather than making a copy of data and moving data to different locations in memory (e.g., a read/write operation), same data in same location of a memory may be used for any number of processing tasks (e.g., at a same time, at different times, etc.). In at least one embodiment, as data is used to generate new data as a result of processing, this information of a new location of data may be stored and shared between various applications. In at least one embodiment, location of data and a location of updated or modified data may be part of a definition of how a payload is understood within containers.

In at least one embodiment, AI service(s) 1418 may be leveraged to perform inferencing services for executing machine learning model(s) associated with applications (e.g., tasked with performing one or more processing tasks of an application). In at least one embodiment, AI service(s) 1418 may leverage AI system 1424 to execute machine learning model(s) (e.g., neural networks, such as CNNs) for segmentation, reconstruction, object detection, feature detection, classification, and/or other inferencing tasks. In at least one embodiment, applications of deployment pipeline(s) 1410 may use one or more of output model(s) 1316 from training system 1304 and/or other models of applications to perform inference on imaging data. In at least one embodiment, two or more examples of inferencing using application orchestration system 1428 (e.g., a scheduler) may be available. In at least one embodiment, a first category may include a high priority/low latency path that may achieve higher service level agreements, such as for performing inference on urgent requests during an emergency, or for a radiologist during diagnosis. In at least one embodiment, a second category may include a standard priority path that may be used for requests that may be non-urgent or where analysis may be performed at a later time. In at least one embodiment, application orchestration system 1428 may distribute resources (e.g., services 1320 and/or hardware 1322) based on priority paths for different inferencing tasks of AI service(s) 1418.

In at least one embodiment, shared storage may be mounted to AI service(s) 1418 within system 1400. In at least one embodiment, shared storage may operate as a cache (or other storage device type) and may be used to process inference requests from applications. In at least one embodiment, when an inference request is submitted, a request may be received by a set of API instances of deployment system 1306, and one or more instances may be selected (e.g., for best fit, for load balancing, etc.) to process a request. In at least one embodiment, to process a request, a request may be entered into a database, a machine learning model may be located from model registry 1324 if not already in a cache, a validation step may ensure appropriate machine learning model is loaded into a cache (e.g., shared storage), and/or a copy of a model may be saved to a cache. In at least one embodiment, a scheduler (e.g., of pipeline manager 1412) may be used to launch an application that is referenced in a request if an application is not already running or if there are not enough instances of an application. In at least one embodiment, if an inference server is not already launched to execute a model, an inference server may be launched. Any number of inference servers may be launched per model. In at least one embodiment, in a pull model, in which inference servers are clustered, models may be cached whenever load balancing is advantageous. In at least one embodiment, inference servers may be statically loaded in corresponding, distributed servers.

In at least one embodiment, inferencing may be performed using an inference server that runs in a container. In at least one embodiment, an instance of an inference server may be associated with a model (and optionally a plurality of versions of a model). In at least one embodiment, if an instance of an inference server does not exist when a request to perform inference on a model is received, a new instance may be loaded. In at least one embodiment, when starting an inference server, a model may be passed to an inference server such that a same container may be used to serve different models so long as inference server is running as a different instance.

In at least one embodiment, during application execution, an inference request for a given application may be received, and a container (e.g., hosting an instance of an inference server) may be loaded (if not already), and a start procedure may be called. In at least one embodiment, pre-processing logic in a container may load, decode, and/or perform any additional pre-processing on incoming data (e.g., using a CPU(s) and/or GPU(s)). In at least one embodiment, once data is prepared for inference, a container may perform inference as necessary on data. In at least one embodiment, this may include a single inference call on one image (e.g., a hand X-ray), or may require inference on hundreds of images (e.g., a chest CT). In at least one embodiment, an application may summarize results before completing, which may include, without limitation, a single confidence score, pixel level-segmentation, voxel-level segmentation, generating a visualization, or generating text to summarize findings. In at least one embodiment, different models or applications may be assigned different priorities. For example, some models may have a real-time (TAT<1 min) priority while others may have lower priority (e.g., TAT<10 min). In at least one embodiment, model execution times may be measured from requesting institution or entity and may include partner network traversal time, as well as execution on an inference service.

In at least one embodiment, transfer of requests between services 1320 and inference applications may be hidden behind a software development kit (SDK), and robust transport may be provide through a queue. In at least one embodiment, a request will be placed in a queue via an API for an individual application/tenant ID combination and an SDK will pull a request from a queue and give a request to an application. In at least one embodiment, a name of a queue may be provided in an environment from where an SDK will pick it up. In at least one embodiment, asynchronous communication through a queue may be useful as it may allow any instance of an application to pick up work as it becomes available. Results may be transferred back through a queue, to ensure no data is lost. In at least one embodiment, queues may also provide an ability to segment work, as highest priority work may go to a queue with most instances of an application connected to it, while lowest priority work may go to a queue with a single instance connected to it that processes tasks in an order received. In at least one embodiment, an application may run on a GPU-accelerated instance generated in cloud 1426, and an inference service may perform inferencing on a GPU.

In at least one embodiment, visualization service(s) 1420 may be leveraged to generate visualizations for viewing outputs of applications and/or deployment pipeline(s) 1410. In at least one embodiment, GPUs/Graphics 1422 may be leveraged by visualization service(s) 1420 to generate visualizations. In at least one embodiment, rendering effects, such as ray-tracing, may be implemented by visualization service(s) 1420 to generate higher quality visualizations. In at least one embodiment, visualizations may include, without limitation, 2D image renderings, 3D volume renderings, 3D volume reconstruction, 2D tomographic slices, virtual reality displays, augmented reality displays, etc. In at least one embodiment, virtualized environments may be used to generate a virtual interactive display or environment (e.g., a virtual environment) for interaction by users of a system (e.g., doctors, nurses, radiologists, etc.). In at least one embodiment, visualization service(s) 1420 may include an internal visualizer, cinematics, and/or other rendering or image processing capabilities or functionality (e.g., ray tracing, rasterization, internal optics, etc.).

In at least one embodiment, hardware 1322 may include GPUs/Graphics 1422, AI system 1424, cloud 1426, and/or any other hardware used for executing training system 1304 and/or deployment system 1306. In at least one embodiment, GPUs/Graphics 1422 (e.g., NVIDIA's TESLA and/or QUADRO GPUs) may include any number of GPUs that may be used for executing processing tasks of compute service(s) 1416, AI service(s) 1418, visualization service(s) 1420, other services, and/or any of features or functionality of software 1318. For example, with respect to AI service(s) 1418, GPUs/Graphics 1422 may be used to perform pre-processing on imaging data (or other data types used by machine learning models), post-processing on outputs of machine learning models, and/or to perform inferencing (e.g., to execute machine learning models). In at least one embodiment, cloud 1426, AI system 1424, and/or other components of system 1400 may use GPUs/Graphics 1422. In at least one embodiment, cloud 1426 may include a GPU-optimized platform for deep learning tasks. In at least one embodiment, AI system 1424 may use GPUs, and cloud 1426—or at least a portion tasked with deep learning or inferencing—may be executed using one or more AI systems 1424. As such, although hardware 1322 is illustrated as discrete components, this is not intended to be limiting, and any components of hardware 1322 may be combined with, or leveraged by, any other components of hardware 1322.

In at least one embodiment, AI system 1424 may include a purpose-built computing system (e.g., a super-computer or an HPC) configured for inferencing, deep learning, machine learning, and/or other artificial intelligence tasks. In at least one embodiment, AI system 1424 (e.g., NVIDIA's DGX) may include GPU-optimized software (e.g., a software stack) that may be executed using a plurality of GPUs/Graphics 1422, in addition to CPUs, RAM, storage, and/or other components, features, or functionality. In at least one embodiment, one or more AI systems 1424 may be implemented in cloud 1426 (e.g., in a data center) for performing some or all of AI-based processing tasks of system 1400.

In at least one embodiment, cloud 1426 may include a GPU-accelerated infrastructure (e.g., NVIDIA's NGC) that may provide a GPU-optimized platform for executing processing tasks of system 1400. In at least one embodiment, cloud 1426 may include an AI system 1424 for performing one or more of AI-based tasks of system 1400 (e.g., as a hardware abstraction and scaling platform). In at least one embodiment, cloud 1426 may integrate with application orchestration system 1428 leveraging multiple GPUs to enable seamless scaling and load balancing between and among applications and services 1320. In at least one embodiment, cloud 1426 may tasked with executing at least some of services 1320 of system 1400, including compute service(s) 1416, AI service(s) 1418, and/or visualization service(s) 1420, as described herein. In at least one embodiment, cloud 1426 may perform small and large batch inference (e.g., executing NVIDIA's TENSOR RT), provide an accelerated parallel computing API and platform 1430 (e.g., NVIDIA's CUDA), execute application orchestration system 1428 (e.g., KUBERNETES), provide a graphics rendering API and platform (e.g., for ray-tracing, 2D graphics, 3D graphics, and/or other rendering techniques to produce higher quality cinematics), and/or may provide other functionality for system 1400.

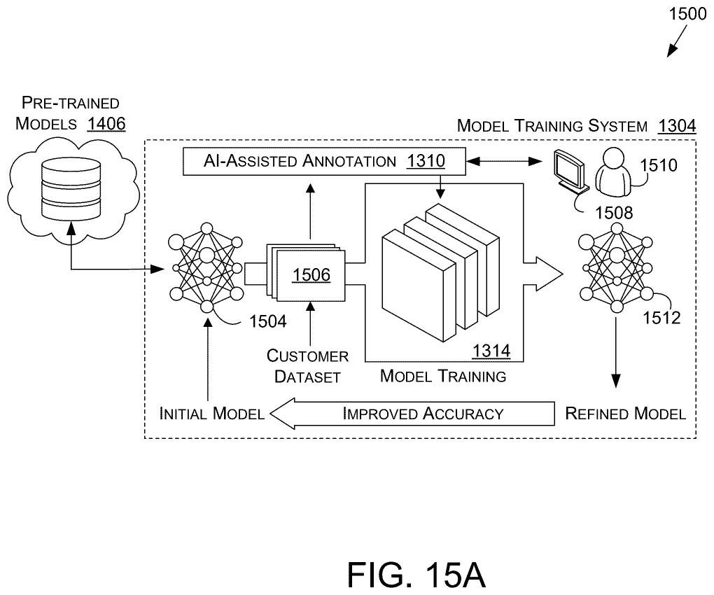

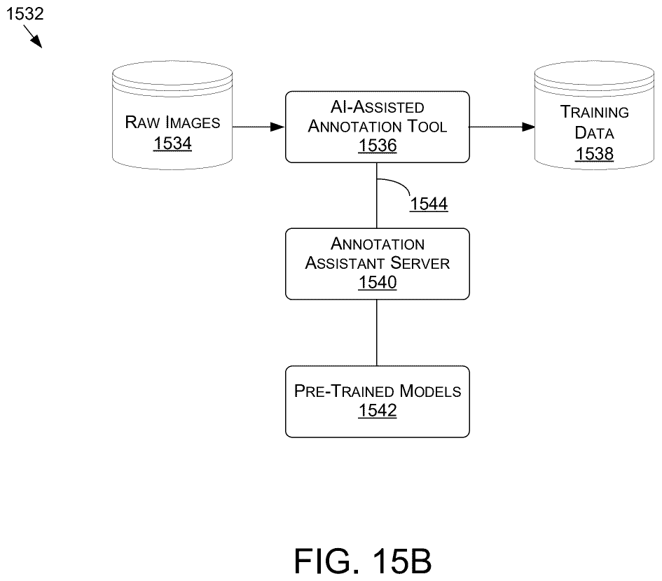

FIG. 15A illustrates a data flow diagram for a process 1500 to train, retrain, or update a machine learning model, in accordance with at least one embodiment. In at least one embodiment, process 1500 may be executed using, as a non-limiting example, system 1400 of FIG. 14. In at least one embodiment, process 1500 may leverage services and/or hardware as described herein. In at least one embodiment, refined models 1512 generated by process 1500 may be executed by a deployment system for one or more containerized applications in deployment pipelines.

In at least one embodiment, model training 1514 may include retraining or updating an initial model 1504 (e.g., a pre-trained model) using new training data (e.g., new input data, such as customer dataset 1506, and/or new ground truth data associated with input data). In at least one embodiment, to retrain, or update, initial model 1504, output or loss layer(s) of initial model 1504 may be reset, deleted, and/or replaced with an updated or new output or loss layer(s). In at least one embodiment, initial model 1504 may have previously fine-tuned parameters (e.g., weights and/or biases) that remain from prior training, so training or retraining 1514 may not take as long or require as much processing as training a model from scratch. In at least one embodiment, during model training 1514, by having reset or replaced output or loss layer(s) of initial model 1504, parameters may be updated and re-tuned for a new data set based on loss calculations associated with accuracy of output or loss layer(s) at generating predictions on new, customer dataset 1506.

In at least one embodiment, pre-trained models 1506 may be stored in a data store, or registry. In at least one embodiment, pre-trained models 1506 may have been trained, at least in part, at one or more facilities other than a facility executing process 1500. In at least one embodiment, to protect privacy and rights of patients, subjects, or clients of different facilities, pre-trained models 1506 may have been trained, on-premise, using customer or patient data generated on-premise. In at least one embodiment, pre-trained models 1306 may be trained using a cloud and/or other hardware, but confidential, privacy protected patient data may not be transferred to, used by, or accessible to any components of a cloud (or other off premise hardware). In at least one embodiment, where pre-trained models 1506 is trained at using patient data from more than one facility, pre-trained models 1506 may have been individually trained for each facility prior to being trained on patient or customer data from another facility. In at least one embodiment, such as where a customer or patient data has been released of privacy concerns (e.g., by waiver, for experimental use, etc.), or where a customer or patient data is included in a public data set, a customer or patient data from any number of facilities may be used to train pre-trained models 1506 on-premise and/or off premise, such as in a datacenter or other cloud computing infrastructure.

In at least one embodiment, when selecting applications for use in deployment pipelines, a user may also select machine learning models to be used for specific applications. In at least one embodiment, a user may not have a model for use, so a user may select a pre-trained model to use with an application. In at least one embodiment, pre-trained model may not be optimized for generating accurate results on customer dataset 1506 of a facility of a user (e.g., based on patient diversity, demographics, types of medical imaging devices used, etc.). In at least one embodiment, prior to deploying a pre-trained model into a deployment pipeline for use with an application(s), pre-trained model may be updated, retrained, and/or fine-tuned for use at a respective facility.

In at least one embodiment, a user may select pre-trained model that is to be updated, retrained, and/or fine-tuned, and this pre-trained model may be referred to as initial model 1504 for a training system within process 1500. In at least one embodiment, a customer dataset 1506 (e.g., imaging data, genomics data, sequencing data, or other data types generated by devices at a facility) may be used to perform model training (which may include, without limitation, transfer learning) on initial model 1504 to generate refined model 1512. In at least one embodiment, ground truth data corresponding to customer dataset 1506 may be generated by training system 1304. In at least one embodiment, ground truth data may be generated, at least in part, by clinicians, scientists, doctors, practitioners, at a facility.

In at least one embodiment, AI-assisted annotation may be used in some examples to generate ground truth data. In at least one embodiment, AI-assisted annotation (e.g., implemented using an AI-assisted annotation SDK) may leverage machine learning models (e.g., neural networks) to generate suggested or predicted ground truth data for a customer dataset. In at least one embodiment, a user may use annotation tools within a user interface (a graphical user interface (GUI)) on a computing device.

In at least one embodiment, user 1510 may interact with a GUI via computing device 1508 to edit or fine-tune (auto) annotations. In at least one embodiment, a polygon editing feature may be used to move vertices of a polygon to more accurate or fine-tuned locations.

In at least one embodiment, once customer dataset 1506 has associated ground truth data, ground truth data (e.g., from AI-assisted annotation, manual labeling, etc.) may be used by during model training to generate refined model 1512. In at least one embodiment, customer dataset 1506 may be applied to initial model 1504 any number of times, and ground truth data may be used to update parameters of initial model 1504 until an acceptable level of accuracy is attained for refined model 1512. In at least one embodiment, once refined model 1512 is generated, refined model 1512 may be deployed within one or more deployment pipelines at a facility for performing one or more processing tasks with respect to medical imaging data.

In at least one embodiment, refined model 1512 may be uploaded to pre-trained models in a model registry to be selected by another facility. In at least one embodiment, this process may be completed at any number of facilities such that refined model 1512 may be further refined on new datasets any number of times to generate a more universal model.

FIG. 15B is an example illustration of a client-server architecture 1532 to enhance annotation tools with pre-trained annotation models, in accordance with at least one embodiment. In at least one embodiment, AI-assisted annotation tool 1536 may be instantiated based on a client-server architecture 1532. In at least one embodiment, AI-assisted annotation tool 1536 in imaging applications may aid radiologists, for example, identify organs and abnormalities. In at least one embodiment, imaging applications may include software tools that help user 1510 to identify, as a non-limiting example, a few extreme points on a particular organ of interest in raw images 1534 (e.g., in a 3D MRI or CT scan) and receive auto-annotated results for all 2D slices of a particular organ. In at least one embodiment, results may be stored in a data store as training data 1538 and used as (for example and without limitation) ground truth data for training. In at least one embodiment, when computing device 1508 sends extreme points for AI-assisted annotation, a deep learning model, for example, may receive this data as input and return inference results of a segmented organ or abnormality. In at least one embodiment, pre-instantiated annotation tools, such as AI-assisted annotation tool 1536 in FIG. 15B, may be enhanced by making API calls (e.g., API Call 1544) to a server, such as an Annotation Assistant Server 1540 that may include a set of pre-trained models 1542 stored in an annotation model registry, for example. In at least one embodiment, an annotation model registry may store pre-trained models 1542 (e.g., machine learning models, such as deep learning models) that are pre-trained to perform AI-assisted annotation on a particular organ or abnormality. These models may be further updated by using training pipelines. In at least one embodiment, pre-installed annotation tools may be improved over time as new labeled data is added.

Various embodiments can be described by the following clauses:
1. A computer-implemented method, comprising:
segmenting a frame into a plurality of regions;
determining a region saliency score for each region of the plurality of regions based on a saliency map for the frame;
generating mitigation data using one or more loss mitigation methods for one or more regions of the plurality of regions determined to be important regions based on the region saliency scores corresponding to the plurality of regions; and
transmitting an encoded video stream for the frame including the mitigation data for the important regions.
2. The computer-implemented method of clause 1, wherein the one or more loss mitigation methods include at least one of forward error correction or packet duplication.
3. The computer-implemented method of clause 2, further comprising:
determining a property of the frame; and identifying the saliency map based on the property.
4. The computer-implemented method of clause 1, further comprising:
determining a level of the one or more loss mitigation methods to apply to at least one region of the one or more regions based on the region saliency score corresponding to the at least one region.
5. The computer-implemented method of clause 1, further comprising:
determining, for the frame, a frame saliency score;
determining, for a first region of the plurality of regions, that a first region saliency score is greater than or equal to the frame saliency score; and
identifying the first region as an important region in response to determining that the first region saliency score is greater than or equal to the frame saliency score.
6. The computer-implemented method of clause 1, wherein at least one saliency score is based on pixel saliency values of pixels within the respective region.
7. The computer-implemented method of clause 1, further comprising:
selecting, based on a first region saliency score, a first loss mitigation method for a first region; and
selecting, based on a second region saliency score, a second loss mitigation method for a second region.
8. The computer-implemented method of clause 1, wherein the frame is part of a streaming video.
9. A processor, comprising:
one or more circuits to:
   generate a set of data packets for a plurality of regions of a frame;
   determine a region saliency value for at least one region of the plurality of regions;
   generate, for one or more regions of the plurality of regions determined to be important regions based on region saliency values corresponding to the plurality of regions, one or more mitigation packets for data packets associated with the respective one or more regions; and
   transmit a data stream including the set of data packets and the one or more mitigation packets corresponding to the important regions.
10. The processor of clause 9, wherein the saliency value for a region of the plurality of regions is based on an average of individual saliency values of pixels within the region.
11. The processor of clause 9, wherein the one or more mitigation packets include information for forward error correction or packet duplication.
12. The processor of clause 9, wherein the one or more circuits are further to:
determine a frame saliency value based on region saliency values corresponding to the plurality of regions;
determine whether a first region, of the plurality of regions, has a first region saliency value greater than or equal to the frame saliency value; and
determine the first region is an important region in response to a determination that the first region saliency value is greater than or equal to the frame saliency value.
13. The processor of clause 9, wherein the one or more circuits are further to:
identify a saliency map for the frame defining saliency values for each pixel in the frame.
14. The processor of clause 9, wherein the processor is comprised in at least one of:
a system for performing simulation operations;
a system for performing simulation operations to test or validate autonomous machine applications;
a system for performing digital twin operations;
a system for performing light transport simulation;
a system for rendering graphical output;
a system for cloud gaming;
a system for streaming content over a network;
a system for performing deep learning operations;
a system implemented using an edge device;
a system for generating or presenting virtual reality (VR) content;
a system for generating or presenting augmented reality (AR) content;
a system for generating or presenting mixed reality (MR) content;
a system incorporating one or more Virtual Machines (VMs);
a system for performing operations for a conversational AI application;
a system for performing operations for a generative AI application;
a system for performing operations using a language model;
a system for performing one or more generative content operations using a large language model (LLM);
a system implemented at least partially in a data center;
a system for performing hardware testing using simulation;
a system for performing one or more generative content operations using a language model;
a system for synthetic data generation;
a collaborative content creation platform for 3D assets; or
a system implemented at least partially using cloud computing resources.
15. A system, comprising:
one or more processing units to determine a region saliency value for a region of a frame and to generate data mitigation packets for inclusion within an encoded video stream when the region saliency value indicates that the region is important.
16. The system of clause 15, wherein the region saliency value corresponds to an average of pixel saliency values in the region.
17. The system of clause 15, wherein the one or more processing units are further to determine a frame saliency value for the frame.
18. The system of clause 17, wherein the region of the frame is indicated as important based on a determination that the region saliency value meets or exceeds the frame saliency value.
19. The system of clause 15, wherein the data mitigation packets include information for forward error correction or packet duplication.
20. The system of clause 15, wherein the system is one of:
a system for performing simulation operations;
a system for performing simulation operations to test or validate autonomous machine applications;
a system for performing digital twin operations;
a system for performing light transport simulation;
a system for rendering graphical output;
a system for cloud gaming;
a system for streaming content over a network;
a system for performing deep learning operations;
a system implemented using an edge device;
a system for generating or presenting virtual reality (VR) content;
a system for generating or presenting augmented reality (AR) content;
a system for generating or presenting mixed reality (MR) content;
a system incorporating one or more Virtual Machines (VMs);
a system for performing operations for a conversational AI application;
a system for performing operations for a generative AI application;
a system for performing operations using a language model;
a system for performing one or more generative content operations using a large language model (LLM);
a system implemented at least partially in a data center;
a system for performing hardware testing using simulation;
a system for performing one or more generative content operations using a language model;
a system for synthetic data generation;
a collaborative content creation platform for 3D assets; or
a system implemented at least partially using cloud computing resources.

Other variations are within spirit of present disclosure. Thus, while disclosed techniques are susceptible to various modifications and alternative constructions, certain illustrated embodiments thereof are shown in drawings and have been described above in detail. It should be understood, however, that there is no intention to limit disclosure to specific form or forms disclosed, but on contrary, intention is to cover all modifications, alternative constructions, and equivalents falling within spirit and scope of disclosure, as defined in appended claims.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. Term “connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. Use of term “set” (e.g., “a set of items”) or “subset,” unless otherwise noted or contradicted by context, is to be construed as a nonempty collection comprising one or more members. Further, unless otherwise noted or contradicted by context, term “subset” of a corresponding set does not necessarily denote a proper subset of corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B, and at least one of C each to be present. In addition, unless otherwise noted or contradicted by context, term “plurality” indicates a state of being plural (e.g., “a plurality of items” indicates multiple items). A plurality is at least two items, but can be more when so indicated either explicitly or by context. Further, unless stated otherwise or otherwise clear from context, phrase “based on” means “based at least in part on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause computer system to perform operations described herein. A set of non-transitory computer-readable storage media, in at least one embodiment, comprises multiple non-transitory computer-readable storage media and one or more of individual non-transitory storage media of multiple non-transitory computer-readable storage media lack all of code while multiple non-transitory computer-readable storage media collectively store all of code. In at least one embodiment, executable instructions are executed such that different instructions are executed by different processors—for example, a non-transitory computer-readable storage medium store instructions and a main central processing unit (“CPU”) executes some of instructions while a graphics processing unit (“GPU”) executes other instructions. In at least one embodiment, different components of a computer system have separate processors and different processors execute different subsets of instructions.

Accordingly, in at least one embodiment, computer systems are configured to implement one or more services that singly or collectively perform operations of processes described herein and such computer systems are configured with applicable hardware and/or software that enable performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of disclosure and does not pose a limitation on scope of disclosure unless otherwise claimed. No language in specification should be construed as indicating any non-claimed element as essential to practice of disclosure.

All references, including publications, patent applications, and patents, cited herein are hereby incorporated by reference to same extent as if each reference were individually and specifically indicated to be incorporated by reference and were set forth in its entirety herein.

In description and claims, terms “coupled” and “connected,” along with their derivatives, may be used. It should be understood that these terms may be not intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, term “processor” may refer to any device or portion of a device that processes electronic data from registers and/or memory and transform that electronic data into other electronic data that may be stored in registers and/or memory. As non-limiting examples, “processor” may be a CPU or a GPU. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. Terms “system” and “method” are used herein interchangeably insofar as system may embody one or more methods and methods may be considered a system.

In present document, references may be made to obtaining, acquiring, receiving, or inputting analog or digital data into a subsystem, computer system, or computer-implemented machine. Obtaining, acquiring, receiving, or inputting analog and digital data can be accomplished in a variety of ways such as by receiving data as a parameter of a function call or a call to an application programming interface. In some implementations, process of obtaining, acquiring, receiving, or inputting analog or digital data can be accomplished by transferring data via a serial or parallel interface. In another implementation, process of obtaining, acquiring, receiving, or inputting analog or digital data can be accomplished by transferring data via a computer network from providing entity to acquiring entity. References may also be made to providing, outputting, transmitting, sending, or presenting analog or digital data. In various examples, process of providing, outputting, transmitting, sending, or presenting analog or digital data can be accomplished by transferring data as an input or output parameter of a function call, a parameter of an application programming interface or interprocess communication mechanism.

Although discussion above sets forth example implementations of described techniques, other architectures may be used to implement described functionality, and are intended to be within scope of this disclosure. Furthermore, although specific distributions of responsibilities are defined above for purposes of discussion, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A computer-implemented method, comprising:
segmenting a frame into a plurality of regions;
determining a region saliency score for each region of the plurality of regions based on a saliency map for the frame;
generating mitigation data using one or more loss mitigation methods for one or more regions of the plurality of regions determined to be important regions based on the region saliency scores corresponding to the plurality of regions; and
transmitting an encoded video stream for the frame including the mitigation data for the important regions.

2. The computer-implemented method of claim 1, wherein the one or more loss mitigation methods include at least one of forward error correction or packet duplication.

3. The computer-implemented method of claim 2, further comprising:
determining a property of the frame; and
identifying the saliency map based on the property.

4. The computer-implemented method of claim 1, further comprising:
determining a level of the one or more loss mitigation methods to apply to at least one region of the one or more regions based on the region saliency score corresponding to the at least one region.

5. The computer-implemented method of claim 1, further comprising:
determining, for the frame, a frame saliency score;
determining, for a first region of the plurality of regions, that a first region saliency score is greater than or equal to the frame saliency score; and
identifying the first region as an important region in response to determining that the first region saliency score is greater than or equal to the frame saliency score.

6. The computer-implemented method of claim 1, wherein at least one saliency score is based on pixel saliency values of pixels within the respective region.

7. The computer-implemented method of claim 1, further comprising:
selecting, based on a first region saliency score, a first loss mitigation method for a first region; and
selecting, based on a second region saliency score, a second loss mitigation method for a second region.

8. The computer-implemented method of claim 1, wherein the frame is part of a streaming video.

9. A processor, comprising:
one or more circuits to:
generate a set of data packets for a plurality of regions of a frame;
determine a region saliency value for at least one region of the plurality of regions;
generate, for one or more regions of the plurality of regions determined to be important regions based on region saliency values corresponding to the plurality of regions, one or more mitigation packets for data packets associated with the respective one or more regions; and
transmit a data stream including the set of data packets and the one or more mitigation packets corresponding to the important regions.

10. The processor of claim 9, wherein the saliency value for a region of the plurality of regions is based on an average of individual saliency values of pixels within the region.

11. The processor of claim 9, wherein the one or more mitigation packets include information for forward error correction or packet duplication.

12. The processor of claim 9, wherein the one or more circuits are further to:
determine a frame saliency value based on region saliency values corresponding to the plurality of regions;
determine whether a first region, of the plurality of regions, has a first region saliency value greater than or equal to the frame saliency value; and
determine the first region is an important region in response to a determination that the first region saliency value is greater than or equal to the frame saliency value.

13. The processor of claim 9, wherein the one or more circuits are further to:
identify a saliency map for the frame defining saliency values for each pixel in the frame.

14. The processor of claim 9, wherein the processor is comprised in at least one of:
a system for performing simulation operations;
a system for performing simulation operations to test or validate autonomous machine applications;
a system for performing digital twin operations;
a system for performing light transport simulation;
a system for rendering graphical output;
a system for cloud gaming;
a system for streaming content over a network;
a system for performing deep learning operations;
a system implemented using an edge device;
a system for generating or presenting virtual reality (VR) content;
a system for generating or presenting augmented reality (AR) content;
a system for generating or presenting mixed reality (MR) content;
a system incorporating one or more Virtual Machines (VMs);
a system for performing operations for a conversational AI application;
a system for performing operations for a generative AI application;
a system for performing operations using a language model;
a system for performing one or more generative content operations using a large language model (LLM);
a system implemented at least partially in a data center;
a system for performing hardware testing using simulation;
a system for performing one or more generative content operations using a language model;
a system for synthetic data generation;
a collaborative content creation platform for 3D assets; or
a system implemented at least partially using cloud computing resources.

15. A system, comprising:
one or more processing units to determine a region saliency value for a region of a frame and to generate data mitigation packets for inclusion within an encoded video stream when the region saliency value indicates that the region is important.

16. The system of claim 15, wherein the region saliency value corresponds to an average of pixel saliency values in the region.

17. The system of claim 15, wherein the one or more processing units are further to determine a frame saliency value for the frame.

18. The system of claim 17, wherein the region of the frame is indicated as important based on a determination that the region saliency value meets or exceeds the frame saliency value.

19. The system of claim 15, wherein the data mitigation packets include information for forward error correction or packet duplication.

20. The system of claim 15, wherein the system is one of:
a system for performing simulation operations;
a system for performing simulation operations to test or validate autonomous machine applications;
a system for performing digital twin operations;
a system for performing light transport simulation;
a system for rendering graphical output;
a system for cloud gaming;
a system for streaming content over a network;
a system for performing deep learning operations;
a system implemented using an edge device;
a system for generating or presenting virtual reality (VR) content;
a system for generating or presenting augmented reality (AR) content;
a system for generating or presenting mixed reality (MR) content;
a system incorporating one or more Virtual Machines (VMs);
a system for performing operations for a conversational AI application;
a system for performing operations for a generative AI application;
a system for performing operations using a language model;
a system for performing one or more generative content operations using a large language model (LLM);
a system implemented at least partially in a data center;
a system for performing hardware testing using simulation;
a system for performing one or more generative content operations using a language model;
a system for synthetic data generation;
a collaborative content creation platform for 3D assets; or
a system implemented at least partially using cloud computing resources.
